(19) United States
(12) Patent Application Publication
(10) Pub. No.: US 2026/0223061 A1
(43) Pub. Date: Jul. 30, 2026

(54) METHOD AND APPARATUS FOR SIDELINK POSITIONING RESOURCE ALLOCATION

(71) Applicant: Huawei Technologies Co., Ltd., Shenzhen (CN)

(72) Inventors: George Calcev, Hoffman Estates, IL (US); Vipul Desai, Palatine, IL (US); Brian Classon, St. Pete Beach, FL (US)

(21) Appl. No.: 19/534,452

(22) Filed: Feb. 9, 2026

Related U.S. Application Data
(63) Continuation of application No. PCT/US2024/041799, filed on Aug. 9, 2024.
(60) Provisional application No. 63/518,781, filed on Aug. 10, 2023.
(60) Provisional application No. 63/586,164, filed on Sep. 28, 2023.

(51) Int. Cl. H04W 64/00; H04W 72/25

(52) U.S. Cl. CPC H04W 64/00; H04W 72/25

(57) ABSTRACT

Methods, apparatuses, and computer readable storage media are provided. An example method includes transmitting sidelink (SL) control information (SCI) on a physical sidelink shared channel (PSSCH). The SCI has a first SCI format and indicates a scheduling of a SL positioning (SL-POS) reference signal. The SCI includes SL-POS reference signal resource information. The SCI includes a format field indicating a second SCI format and fields of the second SCI format. The second SCI format indicates scheduling information for a shared channel. The example method further includes transmitting the SL-POS reference signal and the shared channel in accordance with the SCI.

### PRIORITY CLAIM AND CROSS-REFERENCE

This patent application is a continuation of International Application No. PCT/US2024/041799, filed on Aug. 9, 2024, and entitled “METHOD AND APPARATUS FOR SIDELINK POSITIONING RESOURCE ALLOCATION,” which claims priority to U.S. Provisional Application No. 63/518,781, filed on Aug. 10, 2023, and entitled “METHOD AND APPARATUS FOR SL-PRS RESOURCE ALLOCATION,” and to U.S. Provisional Application No. 63/586,164, filed on Sep. 28, 2023, and entitled “METHOD AND APPARATUS FOR SL-PRS RESOURCE ALLOCATION,” the content of each of which is hereby incorporated by reference herein as if reproduced in its entirety.

### TECHNICAL FIELD

The present disclosure relates generally to managing the allocation of resources sidelink positioning resource allocation in a network, and in particular embodiments, to techniques for configuring and handling sidelink control information and corresponding sidelink positioning reference signals.

### BACKGROUND

The third-generation partnership project (3GPP) has been developing and standardizing several important features with fifth generation (5G) new radio access technology (NR). In Release-16, a work item for NR vehicle-to-everything (V2X) wireless communication with the goal of providing 5G-compatible high-speed reliable connectivity for vehicular communications was completed. This work item provided the basics of NR sidelink communication for applications, such as safety systems and autonomous driving. High data rates, low latencies, and high reliabilities were some of the key areas investigated and standardized.

In Release-17, a work item Sidelink Enhancement was completed to further enhance the capabilities and performance of sidelink communication. One of the important objectives of the work item was to introduce an inter-user equipment (UE) coordination mechanism, where one UE shares preferred or non-preferred resource for another UE to use in its resource selection or sends a conflict indication to another UE if there is a conflict on its reserved resources.

In Release-16, a work item for NR positioning support was completed, which provides positioning support in 5G NR including downlink (DL) and uplink (UL) reference signals for various positioning techniques (DL-TDOA, DL-AOD, UL-TDOA, UL-AOA, multi-cell RTT, and E-CID), as well as the UE and gNB measurements for NR positioning. In Release-17, a work item for NR Positioning Enhancements with the goal of supporting high accuracy, low latency, network efficiency, and device efficiency requirements for commercial uses cases was completed. This work item provided methods, measurements, signaling, and procedures for improving positioning accuracy over Release-16 positioning methods.

In Release-18, a study item on expanded and improved NR positioning was approved, which includes the study of sidelink positioning solutions. This disclosure describes techniques and signaling to enable improved sidelink positioning.

### SUMMARY

Technical advantages are generally achieved, by embodiments of this disclosure which describe sidelink positioning resource allocation.

In accordance with a first aspect of the embodiments, a method of sidelink positioning resource allocation and use is provided. The first example method includes transmitting, by a first user equipment (UE), sidelink (SL) control information (SCI) on a physical sidelink shared channel (PSSCH), the SCI having a first SCI format and indicating a scheduling of a SL positioning (SL-POS) reference signal, where the SCI includes SL-POS reference signal resource information, the SCI includes a format field indicating a second SCI format and fields of the second SCI format, and the second SCI format indicates scheduling information for a shared channel. The first example method further includes transmitting, by the first UE, the SL-POS reference signal and the shared channel in accordance with the SCI.

In some example embodiments, the SL-POS reference signal resource information comprises at least one of an SL-POS reference signal resource identifier or an SL-POS reference signal request.

In some example embodiments, the first SCI format and the second SCI format are 2^{nd} stage SCI format, the second SCI format is SCI format 2-A or SCI format 2-B.

In some example embodiments, the SCI includes a priority associated with at least the SL-POS reference signal.

In some example embodiments, the priority associated with at least the SL-POS reference signal includes a first priority, the SCI includes a second priority associated with other PSSCH data associated with the shared channel, and a priority of a multiplexed slot is assigned to a higher of the first priority and the second priority.

In some example embodiments, the other PSSCH data and the SL-POS reference signal are transmitted in a same slot.

In accordance with a second aspect of the embodiments, another method of sidelink positioning resource allocation and use is provided. The second example method includes transmitting, by a first user equipment (UE) and using a first multiplexing, sidelink (SL) control information (SCI) and demodulation reference signal (DMRS) for SCI decoding. The second example method further includes transmitting, by the first UE and using time division multiplexing, a SL positioning (SL-POS) reference signal in accordance with a SL-POS configuration. The SL-POS reference signal includes a first SL-POS reference signal of at least one SL-POS reference signal associated with at least one UE. The at least one UE includes the first UE, and the SCI includes a first SCI of at least one SCI associated with the at least one UE. Each SL-POS reference signal of the at least one SL-POS reference signal is associated with a corresponding SCI of the at least one SCI, and each corresponding SL-POS reference signal and SCI are associated with a corresponding UE of the at least one UE. The first SCI is multiplexed with each other SCI using the first multiplexing.

In some example embodiments, transmitting the at least one SL-POS reference signal includes transmitting the first SL-POS reference signal multiplexed via the time division multiplexing with a second SL-POS reference signal associated with a second UE.

In some example embodiments, the first multiplexing includes frequency division multiplexing.

In some example embodiments, the first multiplexing includes the time division multiplexing.

In some example embodiments, the SCI and the DMRS are transmitted in a same slot as the at least one SL-POS reference signal.

In some example embodiments, the SCI includes a single stage SCI.

In some example embodiments, for each UE of at least one UE, each SCI is mapped to a corresponding SL-POS reference signal of the at least one SL-POS reference signal.

In some example embodiments, an automatic gain control (AGC) symbol and a guard symbol are provisioned between at least two successively transmitted SL-POS reference signals.

In some example embodiments, the AGC symbol includes a duplication of the SL-POS reference signal.

In some example embodiments, the SCI is of a first SCI configuration including at least one bit triggering requesting transmission of a corresponding SL-POS reference signal.

In accordance with a third aspect of the embodiments, another method of sidelink positioning resource allocation and use is provided. The third example method includes receiving, by a first user equipment (UE), sidelink (SL) control information (SCI) on a physical sidelink shared channel (PSSCH), the SCI having a first SCI format and indicating a scheduling of a SL positioning (SL-POS) reference signal, where the SCI includes SL-POS reference signal resource information, the SCI includes a format field indicating a second SCI format and fields of the second SCI format, and the second SCI format indicates scheduling information for a shared channel. The third example method further includes receiving, by the first UE, the SL-POS reference signal and the shared channel in accordance with the SCI.

In some example embodiments, the SL-POS reference signal resource information includes at least one of SL-POS reference signal resource identifier or SL-POS reference signal request.

In some example embodiments, the first SCI format and the second SCI format are 2^{nd} stage SCI format, the second SCI format is SCI format 2-A or SCI format 2-B.

In some example embodiments, the SCI includes a priority associated with the SL-POS reference signal.

In some example embodiments, the priority associated with at least the SL-POS reference signal includes a first priority, the SCI includes a second priority associated with other PSSCH data associated with at least the shared channel, and a priority of a multiplexed slot is assigned to a higher of the first priority and the second priority.

In some example embodiments, the other PSSCH data and the SL-POS reference signal are transmitted in a same slot.

In accordance with a fourth aspect of the embodiments, another method of sidelink positioning resource allocation and use is provided. The fourth example method includes receiving, by a first user equipment (UE), a first multiplexed transmission of a plurality of sidelink (SL) control information (SCI) associated with one or more other UEs, and a plurality of demodulation reference signals (DMRS), where each DMRS is for decoding of a corresponding SCI of the plurality of SCIs. The fourth example method further includes receiving, by the first UE, a second multiplexed transmission of a plurality of SL positioning (SL-POS) reference signals associated with the one or more other UEs, where each SL-POS reference signal is configured in accordance with at least one SL-POS configuration. The fourth example method further includes determining, by the first UE and using a first multiplexing, the plurality of SCIs by at least decoding the first multiplexed transmission. The fourth example method further includes determining, by the first UE and using time division multiplexing, the plurality of SL-POS reference signals by at least decoding the second multiplexed transmission, where the plurality of SL-POS reference signals correspond to the plurality of SCI associated with the one or more other UEs.

In some example embodiments, receiving the multiplexed transmission of the plurality of SCI associated with the one or more other UEs includes receiving a first SL-POS reference signal associated with a first other UE multiplexed via the time division multiplexing with a second SL-POS reference signal associated with a second other UE.

In some example embodiments, the first multiplexing includes frequency division multiplexing.

In some example embodiments, the first multiplexing includes the time division multiplexing.

In some example embodiments, the SCI and the DMRS are transmitted in a same slot as the plurality of SL-POS reference signals.

In some example embodiments, the SCI includes a single stage SCI.

In some example embodiments, for each UE of the one or more other UEs, each SCI is mapped to a corresponding SL-POS reference signal of the plurality of SL-POS reference signals.

In some example embodiments, determining, using time division multiplexing, the plurality of SL-POS reference signals by at least decoding the second multiplexed transmission is based on an automatic gain control (AGC) symbol and a guard symbol are provisioned between at least two successive SL-POS reference signals.

In some example embodiments, the AGC symbol includes a duplication of a first SL-POS reference signal of the plurality of SL-POS reference signals.

In some example embodiments, the SCI is of a first SCI configuration including at least one bit triggering requesting transmission of a corresponding SL-POS reference signal.

In accordance with a fifth aspect of the embodiments, an apparatus for sidelink positioning resource allocation and use is provided. An example apparatus includes at least one processor and at least one memory. The at least one memory is a non-transitory computer-readable storage medium having at least one computer program of instructions stored thereon. The instructions, when executed by the at least one processor, configure the apparatus to perform each operation of any one of the example methods described herein.

In accordance with a sixth aspect of the embodiments, a non-transitory computer-readable storage medium for sidelink positioning resource allocation and use is provided. An example non-transitory computer-readable storage medium includes at least one computer program having instructions stored thereon. The instructions, when executed by at least one processor, configure the at least one processor to perform each operation of any one of the example methods described herein.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of example in-coverage/out-of-coverage operations in accordance with at least one embodiment of the present disclosure;

FIG. 2 illustrates a diagram of an example resource pool in a resource grid in accordance with at least one embodiment of the present disclosure;

FIG. 3 illustrates a diagram of an example resource grid with PSCCH, PSSCH, and PSFCH resources in accordance with at least one embodiment of the present disclosure;

FIG. 4 illustrates a diagram of an example structure of an S-SSB block in accordance with at least one embodiment of the present disclosure;

FIG. 5 illustrates a diagram of an example UL SRS in accordance with at least one embodiment of the present disclosure;

FIG. 6 illustrates a diagram of an example DL PRS in accordance with at least one embodiment of the present disclosure;

FIG. 7 illustrates a diagram of sensing and resource selection windows of release-16 NR v2X sidelink mode 2;

FIG. 8 illustrates a diagram of example slot formats in accordance with at least one embodiment of the present disclosure;

FIG. 9 illustrates a diagram of example slot formats with SL-PRS in accordance with at least one embodiment of the present disclosure;

FIG. 10 illustrates a diagram of an example linkage of format 1-A to a format field of a second stage SCI in accordance with at least one embodiment of the present disclosure;

FIG. 11 illustrates a diagram of operations of an example method of decoding and interpreting first and second stage SCI in accordance with at least one embodiment of the present disclosure;

FIG. 12 illustrates a diagram of operations of an example method of setting SCI fields in accordance with at least one embodiment of the present disclosure;

FIG. 13 illustrates a diagram of operations of another example method of decoding and interpreting first and second stage SCI in accordance with at least one embodiment of the present disclosure;

FIG. 14 illustrates a diagram of operations of another example method of setting SCI fields in accordance with at least one embodiment of the present disclosure;

FIG. 15 illustrates a diagram of operations of selecting resources for TDM multiplexing in accordance with at least one embodiment of the present disclosure;

FIG. 16 illustrates a diagram of an example SCI format in accordance with at least one embodiment of the present disclosure;

FIG. 17 illustrates a diagram of an example slot format in accordance with at least one embodiment of the present disclosure;

FIG. 18 illustrates a diagram of operations of an example method of resource selection at a UE for multiplexing at least one SL-PRS transmission with existing multiplexed SL-PRS repetitions in accordance with at least one embodiment of the present disclosure;

FIG. 19 illustrates an example communications system in accordance with at least one embodiment of the present disclosure;

FIG. 20 illustrates another communications system in accordance with at least one embodiment of the present disclosure;

FIGS. 21A and 21B illustrate example devices for implementing methods in accordance with at least one embodiment of the present disclosure;

FIG. 22 illustrates an example computing system that may be used for implementing the devices and methods in accordance with at least one embodiment of the present disclosure;

FIG. 23 illustrates a diagram of operations of an example method for configuring SCI and SL-POS resource allocation, for example using a shared resource pool, in accordance with at least one embodiment of the present disclosure;

FIG. 24 illustrates a diagram of operations of an example method for configuring SCI and SL-POS resource allocation, for example using a dedicated resource pool, in accordance with at least one embodiment of the present disclosure;

FIG. 25 illustrates a diagram of operations of an example method for decoding and interpreting SCI and SL-POS signals, for example using a shared resource pool, in accordance with at least one embodiment of the present disclosure; and

FIG. 26 illustrates a diagram of operations of an example method for decoding and interpreting SCI and SL-POS signals, for example using a dedicated resource pool, in accordance with at least one embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

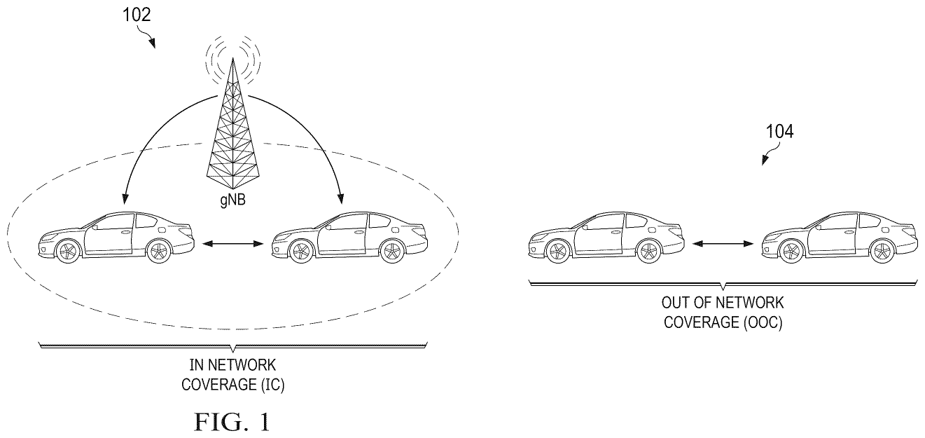

Sidelink communication can either be in-coverage, or out-of-coverage: with in-coverage (IC) operation, a central node (eNB, gNB) is present and can be used to manage the sidelink (mode 1). In mode 2 operation, system operation is fully distributed, and UEs select resources on their own. In this disclosure, some UEs could also be facilitated/assisted in selecting their resources. Note in mode 2, UEs can be either IC 102 or out-of-coverage (OOC) 104. FIG. 1 depicts a diagram of example in-coverage/out-of-coverage operations, in at least one context of embodiments of the present disclosure.

For the purposes of sidelink communications, the notion of resource pools was introduced for LTE sidelink and is being reused for NR sidelink. A resource pool is a set of resources that can be used for sidelink communication. Resources in a resource pool are configured for different channels including control channels, shared channels, feedback channels, synchronization signals, reference signals, broadcast channels (e.g., master information block), and so on. The 3GPP standard (TS 38.214) defines rules on how the resources are shared and used for a particular configuration of the resource pool.

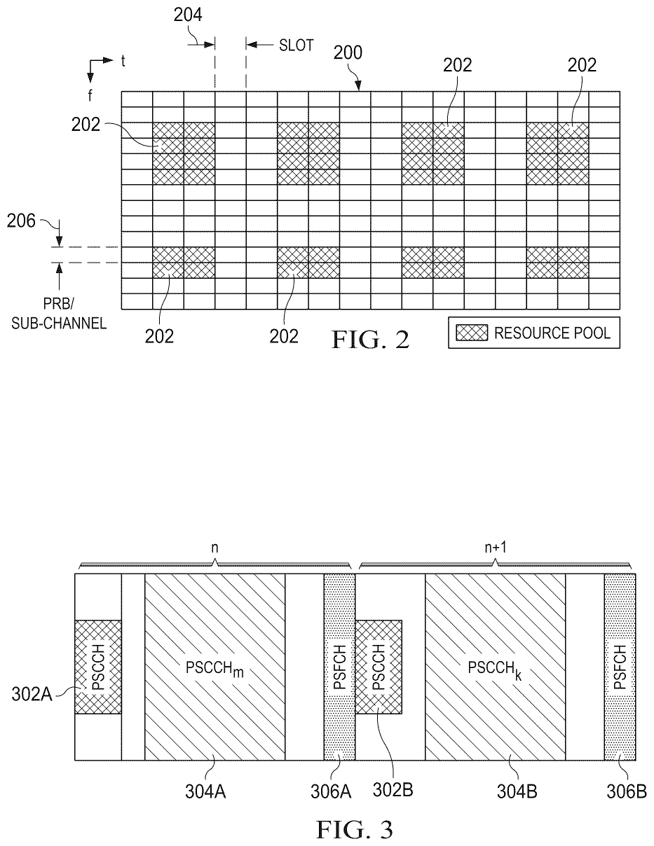

A resource pool for sidelink can be configured in units of slots in the time domain and physical resource blocks (PRBs) or sub-channels in the frequency domain. A sub-channel consists of one or more PRBs. FIG. 2 illustrates a diagram of an example resource pool in a resource grid in accordance with at least one embodiment of the present disclosure. Specifically, FIG. 2 depicts a diagram of resource grid 200 including a resource pool 202 in various defined slots and, such as slot 204, and PRB/sub-channels, including PRB/sub-channel 206.

Additionally or alternatively, FIG. 3 illustrates a diagram of an example resource grid with PSCCH, PSSCH, and physical sidelink feedback channel (PSFCH) resources in accordance with at least one embodiment of the present disclosure. Specifically, FIG. 3 depicts a diagram of two symbols, an n symbol and an n+1 symbol. The first (n) signal includes a first PSCCH 302A, a first PSSCHₘ, and a first PSFCH 306A. The second (n+1) signal includes a second PSCCH 302B, a second PSSCHₖ 304B, and a second PSFCH 306B.

For NR mobile broadband (MBB), each physical resource block (PRB) in the grid is defined as a slot of 14 consecutive OFDM symbols in the time domain and 12 consecutive subcarriers in the frequency domain, i.e., each resource block contains 12×14 resource elements (REs). In some embodiments, when used as a frequency-domain unit, a PRB is 12 consecutive subcarriers. In some embodiments, there are 14 symbols in a slot when a normal cyclic prefix (CP) is used and 12 symbols in a slot when an extended cyclic prefix (ECP) is used. The duration of a symbol is inversely proportional to the subcarrier spacing (SCS). For a {15, 30, 60, 120} kHz SCS, the duration of a slot is {1, 0.5, 0.25, 0.125} ms, respectively. Each PRB may be allocated to combinations of a control channel (CCH), a shared channel (SCH), a feedback channel, reference signals (RS), and so on. In addition, some REs of a PRB may be reserved. A similar structure is used on the sidelink as well. A communication resource may occupy a PRB, a set of PRBs, and use a code (for example, if CDMA is used, similarly as for the PUCCH), a physical sequence, a set of REs, and so on.

The physical sidelink control channel (PSCCH) carries sidelink control information (SCI). The source UE uses the SCI to schedule the transmission of data on the physical sidelink shared channel (PSSCH). The SCI can convey the time and frequency resources of the PSSCH, parameters for hybrid automatic repeat request (HARQ) process, such as the redundancy version, process id, new data indicator, and resources for the physical sidelink feedback channel (PFSCH). The PFSCH can carry an indication (HARQ-ACK) of whether the recipient [destination] UE decoded the payload carried on PSSCH correctly (e.g. an acknowledgement or negative acknowledgement (ACK/NACK). The SCI can also carry a bit field indicating a representation of the identity of the source UE. In addition, the SCI can also carry a bit field indicating a representation of the identity of the destination UE(s). Other fields include the modulation coding scheme (MCS) used to encode the payload and modulate the coded payload bits; the demodulation reference signal (DMRS) pattern, the antenna ports, and priority of the payload (transmission).

The NR sidelink control information (SCI), can be transmitted in two stages. A first stage (shown below) can use SCI Format 1-A and a second stage can use SCI Formats 2-A, B or C. The first stage indicates the resources for the second stage SCI.

SCI Format 1-A (from TS 38.212):

SCI format 1-A is used for the scheduling of PSSCH and 2nd-stage-SCI on PSSCH.

The following information is transmitted by means of the SCI format 1-A:
Priority—3 bits as defined in clause 5.4.3.3 of [12, TS 23.287].
Frequency resource assignment—

$$⌈ {log}_{2} ( \frac{{N}_{subChannel}^{S L} ( {N}_{subChannel}^{S L} + 1 )}{2} ) ⌉$$

bits when the value of the higher layer parameter sl-MaxNumPerReserve is configured to 2; otherwise

$$⌈ {log}_{2} ( \frac{{N}_{subChannel}^{S L} ( {N}_{subChannel}^{S L} + 1 ) ( 2 {N}_{subChannel}^{S L} + 1 )}{6} ) ⌉$$

bits when the value of the higher layer parameter sl-MaxNumPerReserve is configured to 3, as defined in clause 8.1.2.2 of [6, TS 38.214].
Time resource assignment—5 bits when the value of the higher layer parameter sl-MaxNumPerReserve is configured to 2; otherwise 9 bits when the value of the higher layer parameter sl-MaxNumPerReserve is configured to 3, as defined in clause 8.1.2.1 of [6, TS 38.214].
Resource reservation period—┌log₂ N_{rsv_period}┐ bits as defined in clause 8.1.4 of [6, TS 38.214], where N_{rsv_period} is the number of entries in the higher layer parameter sl-ResourceReservePeriodList, if higher layer parameter sl-MultiReserveResource is configured; 0 bit otherwise.
DMRS pattern—┌log₂ Nₚₐₜₜₑᵣₙ┐ bits as defined in clause 8.4.1.1.2 of [4, TS 38.211], where Nₚₐₜₜₑᵣₙ is the number of DMRS patterns configured by higher layer parameter sl-PSSCH-DMRS-TimePatternList; 0 bit if sl-PSSCH-DMRS-TimePatternList is not configured.
2nd-stage SCI format—2 bits as defined in Table 8.3.1.1-1.
Beta_offset indicator—2 bits as provided by higher layer parameter sl-BetaOffsets2ndSCI and Table 8.3.1.1-2.
Number of DMRS port—1 bit as defined in Table 8.3.1.1-3.
Modulation and coding scheme—5 bits as defined in clause 8.1.3 of [6, TS 38.214].
Additional MCS table indicator—as defined in clause 8.1.3.1 of [6, TS 38.214]: 1 bit if one MCS table is configured by higher layer parameter sl-Additional-MCS-Table; 2 bits if two MCS tables are configured by higher layer parameter sl-Additional-MCS-Table; 0 bit otherwise.
PSFCH overhead indication—1 bit as defined clause 8.1.3.2 of [6, TS 38.214] if higher layer parameter sl-PSFCH-Period=2 or 4; 0 bit otherwise.
Reserved—a number of bits as determined by higher layer parameter sl-NumReservedBits, with value set to zero.
   SCI Format 2-A (from TS38.212)

SCI format 2-A is used for the decoding of PSSCH, with HARQ operation when HARQ-ACK information includes ACK or NACK, or when there is no feedback of HARQ-ACK information.

The following information is transmitted by means of the SCI format 2-A:
HARQ process number—┌log₂ N_{process}┐ bits as defined in clause 16.4 of [5, TS 38.213].
New data indicator—1 bit as defined in clause 16.4 of [5, TS 38.213].
Redundancy version—2 bits as defined in clause 16.4 of [6, TS 38.214].
Source ID—8 bits as defined in clause 8.1 of [6, TS 38.214].
Destination ID—16 bits as defined in clause 8.1 of [6, TS 38.214].
HARQ feedback enabled/disabled indicator—1 bit as defined in clause 16.3 of [5, TS 38.213].
Cast type indicator—2 bits as defined in Table 8.4.1.1-1.
CSI request—1 bit as defined in clause 8.2.1 of [6, TS 38.214].

TABLE 8.4.1.1-1
Cast type indicator

| Value of Cast | |
|---|---|
| type indicator | Cast type |
| 00 | Broadcast |
| 01 | Groupcast |
| 10 | Unicast |
| 11 | Reserved |

SCI format 2-B (From TS38.212)
SCI format 2-B is used for the decoding of PSSCH, with HARQ operation when HARQ-ACK information includes only NACK, or when there is no feedback of HARQ-ACK information.

The following information is transmitted by means of the SCI format 2-B:
HARQ process number—┌log₂ N_{process}┐ bits as defined in clause 16.4 of [5, TS 38.213].
New data indicator—1 bit as defined in clause 16.4 of [5, TS 38.213].
Redundancy version—2 bits as defined in clause 16.4 of [6, TS 38.214].
Source ID—8 bits as defined in clause 8.1 of [6, TS 38.214].
Destination ID—16 bits as defined in clause 8.1 of [6, TS 38.214].
HARQ feedback enabled/disabled indicator—1 bit as defined in clause 16.3 of [5, TS 38.213].
Zone ID—12 bits as defined in clause 5.8.1.1 of [9, TS 38.331].
Communication range requirement—4 bits as defined in [9, TS 38.331]

SCI format 2-C (From TS38.212)

SCI format 2-C is used for the decoding of PSSCH and providing inter-UE coordination information or requesting inter-UE coordination information.

The following information is transmitted by means of the SCI format 2-C:
HARQ process number—4 bits.
New data indicator—1 bit.
Redundancy version—2 bits as defined in Table 7.3.1.1.1-2.
Source ID—8 bits as defined in clause 8.1 of [6, TS 38.214].
Destination ID—16 bits as defined in clause 8.1 of [6, TS 38.214].
HARQ feedback enabled/disabled indicator—1 bit as defined in clause 16.3 of [5, TS 38.213].
CSI request—1 bit as defined in clause 8.2.1 of [6, TS 38.214] and in clause 8.1 of [6, TS 38.214].
Providing/Requesting indicator—1 bit, where value 0 indicates SCI format 2-C is used for providing inter-UE coordination information and value 1 indicates SCI format 2-C is used for requesting inter-UE coordination information.

If the ‘Providing/Requesting indicator’ field is set to 0, all the remaining fields are set as follows:
Resource combinations—

$$2 \cdot ( ⌈ {log}_{2} ( \frac{{N}_{subChannel}^{S L} ( {N}_{subChannel}^{S L} + 1 ) ( 2 {N}_{subChannel}^{S L} + 1 )}{6} ) ⌉ + 9 + Y )$$

bits as defined in Clause 8.1.5A of [6, TS 38.214], where:
Y=┌log₂ N_{rsv_period}┐ and N_{rsv_period} is the number of entries in the higher layer parameter sl-ResourceReservePeriodList, if higher layer parameter sl-MultiReserveResource is configured; Y=0 otherwise:

$${N}_{s u b C h a nnel}^{s L}$$

is the number of subchannels in a resource pool provided by the higher layer parameter sl-NumSubchannel.
First resource location—8 bits as defined in Clause 8.1.5A of [6, TS 38.214].
Reference slot location—(10+┌log₂(10·2^{μ})┐) bits as defined in Clause 8.1.5A of [6, TS 38.214], where u is defined in Table 4.2-1 of Clause 4.2 of [4, TS 38.211].
Resource set type—1 bit, where value 0 indicates preferred resource set and value 1 indicates non-preferred resource set.
Lowest subChannel indices—

$$2 \cdot ⌈ {log}_{2} {N}_{subChannel}^{SL} ⌉$$

bits as defined in Clause 8.1.5A of [6, TS 38.214].

If the ‘Providing/Requesting indicator’ field is set to 1, all the remaining fields are set as follows:
Priority—3 bits as specified in clause 5.4.3.3 of [12, TS 23.287] and clause 5.22.1.3.1 of [8, TS 38.321]. Value ‘000’ of Priority field corresponds to priority value ‘1’, value ‘001’ of Priority field corresponds to priority value ‘2’, and so on.
Number of subchannels—

$$⌈ {log}_{2} {N}_{s u b C h a nnel}^{S L} ⌉$$

bits as defined in Clause 8.1.4A of [6, TS 38.214].
Resource reservation period—┌log₂ N_{rsv_period}┐ bits as defined in Clause 8.1.4A of [6, TS 38.214], where N_{rsv_period} is the number of entries in the higher layer parameter sl-ResourceReservePeriodList, if higher layer parameter sl-MultiReserveResource is configured; 0 bit otherwise.
Resource selection window location—2·(10+┌log₂(10·2^{μ})┐) bits as defined in Clause 8.1.4A of [6, TS 38.214], where u is defined in Table 4.2-1 of Clause 4.2 of [4, TS 38.211].
Resource set type—1 bit, where value 0 indicates a request for inter-UE coordination information providing preferred resource set and value 1 indicates a request for inter-UE coordination information providing non-preferred resource set, if higher layer parameter determineResourceSetTypeScheme1 is configured to ‘UE-B's request’; otherwise, 0 bit.

- Padding bits.
Higher Layer Messages (from TS38.331)

| | |
|---|---|
| SL-PSCCH-Config-r16 ::= | SEQUENCE { |
| sl-TimeResourcePSCCH-r16 | ENUMERATED {n2, n3} |

OPTIONAL, -- Need M

| | |
|---|---|
| sl-FreqResourcePSCCH-r16 | ENUMERATED {n10,n12, n15, |
| | n20, n25} |

OPTIONAL, -- Need M

| | |
|---|---|
| sl-DMRS-ScrambleID-r16 | INTEGER (0..65535) |

OPTIONAL, -- Need M

| | |
|---|---|
| sl-NumReservedBits-r16 | INTEGER (2..4) |

```
      OPTIONAL, -- Need M
  ...
}
```

TABLE 1
(SL-PSCCH field descriptions):
SL-PSCCH field descriptions

sl-FreqResourcePSCCH
Indicates the number of PRBs for PSCCH in a resource pool where it is not greater than the
number PRBs of the subchannel.
sl-DMRS-ScrambleID
Indicates the initialization value for PSCCH DMRS scrambling.
sl-NumReservedBits
Indicates the number of reserved bits in first stage SCI.
sl-TimeResourcePSCCH
Indicates the number of symbols of PSCCH in a resource pool.

### Sidelink Inter-UE Coordination

In Rel-17, sidelink inter-UE coordination (IUC) is specified to improve mode 2 reliability by overcoming the issues such as hidden-node, exposed-node, and half-duplex, that impact sidelink performance. In particular, two IUC schemes were defined, i.e.:
Scheme 1: inter-UE coordination information signalling from UE-A to UE-B
   Set of resources preferred for UE-B's transmission
   Set of resources non-preferred for UE-B's transmission
Scheme 2: inter-UE coordination information signalling from UE-A to UE-B
   Presence of expected/potential resource conflict on the resources indicated by UE-B's SCI

In IUC Scheme 1, two IUC triggering scenarios were considered and specified, i.e., 1) Coordination triggered by an explicit request where UE-B sends explicit request to UE-A and UE-A, upon request, generates and sends the coordination information (preferred resource set or non-preferred resource set to UE-B; and 2) Coordination triggered by a condition other than an explicit request where a UE (UE-A) that satisfies certain condition(s) generates and sends coordination information to UE-B.

The conditions for the two IUC triggering scenarios were also specified. For IUC triggered by an explicit request, one of the two conditions is configured for the resource pool level, i.e., alt 1—up to UE-B's implementation and alt 2—the request can be triggered only when UE-B has data to be transmitted to UE-A. Similarly, for IUC triggered by a condition, two conditions are present with one of them enabled by resource pool level configuration or pre-configuration, i.e., alt 1—up to UE-A's implementation, and alt 2—the coordination can be triggered only when UE-A has data to be transmitted together with coordination information to UE-B.

The criteria for generating the coordination information, i.e., preferred resource set and non-preferred resource set are defined as follows:
Preferred resource set:
   Condition 1-A-1: Resource(s) excluding the overlapped reserved resource(s) of other UE with RSRP larger than a threshold.
   Condition 1-A-2: Resource(s) excluding the slots when UE-A, as Rx of UE-B, does not expect to perform SL reception from UE-B.
Non-preferred resource set:
   Condition 1-B-1: Reserved resource(s) of other UE identified by and RSRP measurement.
      Option 1: Reserved resource(s) of other UE(s) identified by UE-A whose RSRP measurement is larger than a (pre) configured RSRP threshold.
      Option 2: Reserved resource(s) of other UE identified by UE-A whose RSRP measurement is smaller than a configured, or pre-configured, RSRP threshold when UE-A is a destination of a TB transmitted by the UE(s).
   Condition 1-B-2: Resource(s) (e.g., slot(s)) where UE-A, when it is intended receiver of UE-B, does not expect to perform SL reception from UE-B.

To send explicit request and coordination information, a MAC-CE is used as the container. If configured, the 2^{nd} stage SCI, SCI-2C, is also used for explicit request or coordination information.

For coordination triggered by an explicit request, only unicast is supported for both transmissions of explicit request and coordination information. For coordination triggered by a condition, unicast is supported for transmission of both types of coordination information. Broadcast and groupcast are supported for non-preferred resource set only.

The coordination information and explicit request can be transmitted multiplexed with data only if source/destination ID pair is the same.

### Sidelink Synchronization Signal Block (S-SSB)

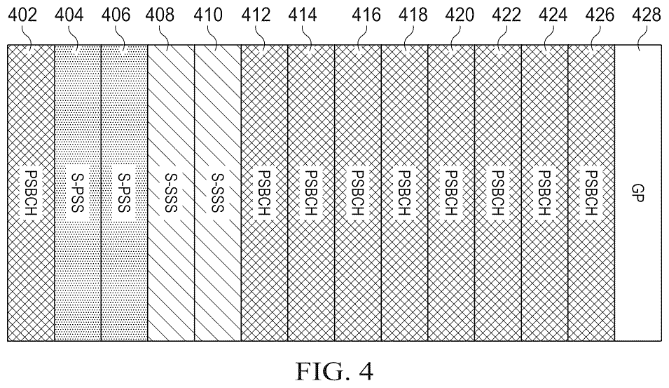

A synchronization slot in sidelink, i.e., Sidelink Synchronization Signal Block (S-SSB) is specified for one UE to synchronize with another UE. As shown in FIG. 4, the first OFDM symbol 402 is for PSBCH. But like the regular sidelink slot, the first symbol is for the settling of the AGC. After which, there are two symbols for S-PSS 404 and 406 and two for the S-SSS 408 and 410. Eight of the remaining nine symbols are for PSBCH transmission 412-426. The last symbol is guard period (GP) 428, same as in the regular sidelink slot.

In the frequency domain, the S-SSB occupies 11 PRBs with total 132 subcarriers. PSBCH occupies all 11 PRBs while the size of synchronization signal is 127 thus S-PSS and S-SSS occupy 127 subcarriers.

The periodicity of S-SSB is 160 ms. The frequency location of the S-SSB is pre-configured. The number of S-SSB transmissions is set to 1 for FR1 and is configurable for FR2.

### Sounding Reference Signal (SRS)

In NR, as specified in 38.211, an SRS resource with 1, 2, or 4 antenna ports is supported which can be mapped to

$${N}_{s y m b}^{S R S} ∈ \{ 1 , 2 , 4 , 8 , 12 \}$$

consecutive OFDM symbols. Comb transmission on every K_{TC}=2 or 4 or 8 REs in the frequency domain is supported. In addition, cyclic shift is supported with the maximum number of cyclic shifts,

$${n}_{SRS}^{cs , max} ,$$

equal to 8, 12, and 6 when size of comb is 2, 4, and 8, respectively. SRS sequence ID is configured by higher layer parameter. The starting OFDM symbol l₀ in the time domain is defined by an offset l_{offset} from the end of the slot, where l_{offset}∈{0, 1, . . . , 13} indicating the starting position can be any OFDM symbol in the slot. The frequency starting position is also specified. For positioning, an additional offset in frequency domain

$${k}_{offset}^{{l}^{′}}$$

was specified which is also dependent of the OFDM symbol configured for SRS transmissions. An SRS resource may be configured for periodic, semi-persistent, aperiodic SRS transmission. In the frequency domain, SRS allocation is aligned with the 4 PRB grid. Frequency hopping is supported as in the case of LTE. With same design approach, NR SRS bandwidth and hopping configuration are designed to cover a larger span of values compared to that of LTE.

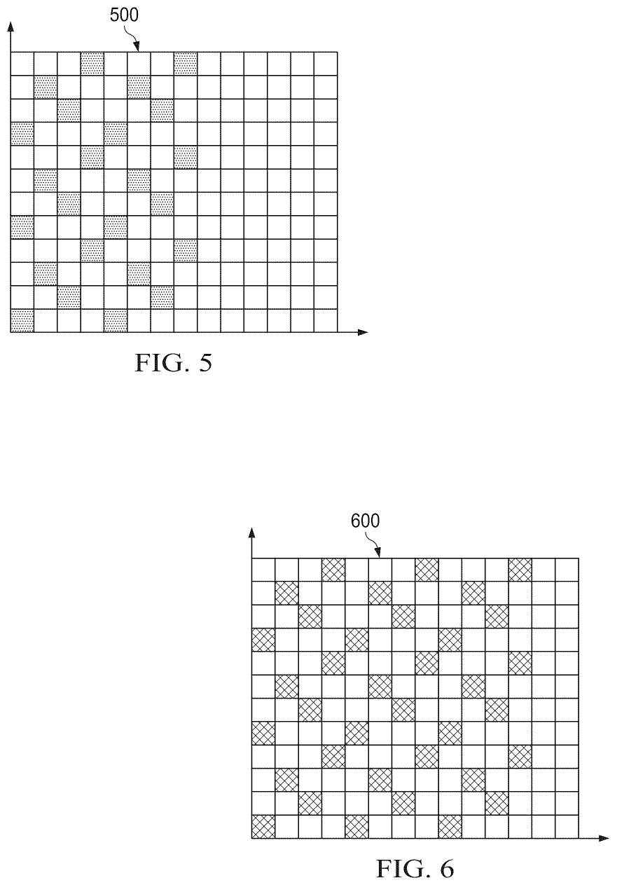

As specified in 38.211, an SRS resource is configured by the SRS-Resource IE for UL channel sounding or the SRS-PosResource IE for positioning purposes. FIG. 5 depicts a diagram of an example UL SRS 500. The UL SRS 500 includes a comb size K_{TC}=4 on

$${N}_{symb}^{SRS} = 8$$

OFDM symbols in a slot.

The UE can be configured with one or more SRS resource sets. For each SRS resource set, a UE may be configured with a number of SRS resources. The use case (such as beam management, codebook-based uplink MIMO, and non-codebook-based uplink MIMO, and antenna switching which actually is for general downlink CSI acquisition) for an SRS resource set is configured by the higher layer parameter.

In the time domain at slot level, an SRS resource can be configured periodically with a periodicity T_{SRS} (in slots) and slot offset T_{offset}.

TABLE 6.4.1.4.2-1
$\begin{matrix}M aximum number of cyclic shifts {n}_{SRS}^{cs , m ax} as a function of {K}_{TC} . \\ ( TS 38.211 )\end{matrix}$

| K_{TC} | ${n}_{SRS}^{cs , m ax}$ |
|---|---|
| 2 | 8 |
| 4 | 12 |
| 8 | 6 |

TABLE 6.4.1.4.3-2
$The offset {k}_{offset}^{{l}^{′}} for SRS as a function of {K}_{TC} and {l}^{′} .$

| | ${k}_{offset}^{0} , … , {k}_{offset}^{{N}_{symb}^{SRS} - 1}$ | | | | |
|---|---|---|---|---|---|
| K_{TC} | ${N}_{symb}^{SRS} = 1$ | ${N}_{symb}^{SRS} = 2$ | ${N}_{symb}^{SRS} = 4$ | ${N}_{symb}^{SRS} = 8$ | ${N}_{symb}^{SRS} = 12$ |
| 2 | 0 | 0, 1 | 0, 1, 0, 1 | — | — |
| 4 | — | 0, 2 | 0, 2, 1, 3 | 0, 2, 1, 3, | 0, 2, 1, 3, 0, 2, 1, |
| | | | | 0, 2, 1, 3 | 3, 0, 2, 1, 3 |
| 8 | — | — | 0, 4, 2, 6 | 0, 4, 2, 6, | 0, 4, 2, 6, 1, 5, 3, |
| | | | | 1, 5, 3, 7 | 7, 0, 4, 2, 6 |

### Positioning Reference Signal (PRS)

Positioning reference signal (PRS) is the downlink reference signal for positioning purpose. PRS is also called DL-PRS while the UL SRS configured for positioning is sometimes called UL-PRS.

DL-PRS is specified with a starting symbol

$${l}_{start}^{P R S} ∈ \{ 0 , … , 12 \} ,$$

the size (number of OFDM symbols) of PRS L_{PRS}∈{2,4,6,12}, the frequency domain interval of two DL-PRS resource-elements (i.e., the comb size)

$${K}_{c o m b}^{P R S} ∈ \{ 2 , 4 , 6 , 12 \}$$

which is selected from a specified subset of

$$\{ {L}_{PRS} , {K}_{c o m b}^{P R S} \}$$

combinations, the initial frequency domain offset

$${k}_{offset}^{PRS} ∈ \{ 0 , 1 , … , {K}_{comb}^{PRS} - 1 \} ,$$

and, similarly as the UL-SRS for positioning, an additional frequency domain offset k′ specified in a table (Table 7.4.1.7.3-1 of TS38.211) which varies over OFDM symbol to symbol.

TABLE 7.4.1.7.3-1
$The frequency offset {k}^{′} as a function of l - {l}_{start}^{PRS} .$

| | $\begin{matrix}Symbol number within the downlink \\ PRS resource l - {l}_{start}^{PRS}\end{matrix}$ | | | | | | | | | | | |
|---|---|---|---|---|---|---|---|---|---|---|---|---|
| ${K}_{comb}^{PRS}$ | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

In the time domain at the slot level, DL-PRS can be configured with a periodicity

$${T}_{p e r}^{P R S} ∈ {2}^{μ} \{ 4 , 5 , 8 , 10 , 16 , 20 , 32 , 40 , 64 , 80 , 160 , 320 , 640 , 1280 , 2560 , 5120 , 10240 \}$$

and a slot offset

$${T}_{offset}^{P R S} ∈ \{ 0 , 1 , … , {T}_{p e r}^{P R S} - 1 \} ,$$

as well as an additional slot offset

$${T}_{offset , res}^{P R S} .$$

The bandwidth of the DL-PRS can be configured in a range from 24 to 275 PRBs with an operation of 4 PRBs. FIG. 6 depicts a diagram of an example DL PRS 600. The DL PRS 600 includes a comp size

$${K}_{c o m b}^{P R S} = 4 , {l}_{s t a r t}^{P R S} = 0 ,$$

and L_{PRS}=12 OFDM symbols in a slot.

### SL Positioning in 3GPP Rel-18

Discussion for 3GPP to develop sidelink positioning solutions occurred in the 3GPP Rel-18 planning phase. It has been shown that various important use cases can benefit from the SL positioning, such as the V2x and public safety use cases in TR 38.845, ranging-based services in TS22.261, and IIoT use cases (TS22.104).

At RANP #94, a Rel-18 study item on expanded and improved NR positioning (RP-213588) was agreed, which includes an objective of SL positioning as:
Study and evaluate performance and feasibility of potential solutions for SL positioning, considering relative positioning, ranging and absolute positioning: [RAN1, RAN2]
   Evaluate bandwidth requirement needed to meet the identified accuracy requirements [RAN1].
   Study of positioning methods (e.g. TDOA, RTT, AOA/D, and the like) including combination of SL positioning measurements with other RAT dependent positioning measurements (e.g. Uu based measurements) [RAN1].
   Study of sidelink reference signals for positioning purposes from physical layer perspective, including signal design, resource allocation, measurements, associated procedures, and the like, reusing existing reference signals, procedures, and the like, from sidelink communication and from positioning as much as possible [RAN1].
   Study of positioning architecture and signalling procedures (e.g. configuration, measurement reporting, and the like) to enable sidelink positioning covering both UE based and network based positioning [RAN2, including coordination and alignment with RAN3 and SA2 as required].

### Sidelink Resource Allocation

### Mode 1 Resource Allocation

In Rel-16 NR V2X sidelink mode 1, the gNB performs scheduling of the sidelink, i.e., gNB allocates the SL resources for SL communications, and the resource allocation is sent to the UE through the NR Uu interface. Therefore, sidelink mode 1 is applicable to UEs under the coverage of a gNB. The resources allocated with mode-1 can be either on the same carrier as cellular NR or a dedicated sidelink carrier.

There are three types of mode 1 resource allocations, i.e., dynamic assignment, type 1 configured grant (CG), and type 2 configured grant. In dynamic assignment, the UE first sends a scheduling request (SR) for every TB to the gNB via the PUCCH. Then gNB sends a SL resource allocation to the UE via DCI format 3_0 over the PDCCH. In CG based resource allocation, UE first sends a message to the gNB with the expected SL traffic, e.g., periodicity, the TB maximum size, and QoS information. The gNB provides resource allocation, i.e., a CG to the UE the gNB provides by RRC signaling. In type 1 CG, the UE can use the resource allocation immediately. In type 2 CG, the UE uses the allocated resources only after activated by gNB via a DCI.

### Mode 2 Resource Allocation

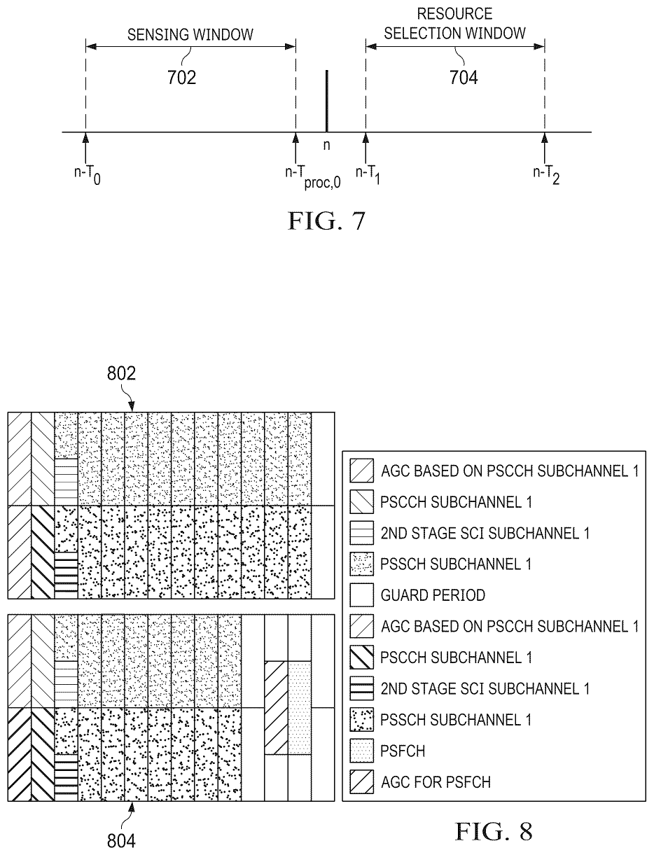

In Rel-16 sidelink, mode 2 UEs transmit and receive information without the need of the network management. UEs themselves allocate the resources from a resource pool for sidelink transmissions. Resource allocation relies on a sensing and reservation process as shown in FIG. 7. During the sensing procedure, a monitoring UE detects SCI transmitted in each slot in the sensing window and measures RSRP of the resource indicated in the SCI. A monitoring UE may also receive transmissions of data (and/or also be a receiving UE). For periodic traffic, the resource reservations for sidelink transmissions, if a UE occupies a resource on slot sₖ, it will also occupy the resource on slot sₖ+q*RRIₖ where q is an integer, RRIₖ is resource reservation interval for UE k that the sensing UE detected. Detecting the SCI includes the operations of receiving and decoding the PSCCH and processing the SCI within the PSCCH.

For aperiodic or dynamic transmissions, the transmitting UE reserves multiple resources and indicates the next resource in the SCI. Therefore, based on the sensing results, a monitoring UE can determine which resources may be occupied in the future and can avoid them for its own transmission if the measured RSRP on the occupied resource during the sensing period is above the RSRP threshold in the resource exclusion procedure as described in TS38.214.

FIG. 7 shows the timing information on the sensing and resource selection for Rel-16 NR sidelink transmission, which is usually referred as full sensing. Specifically FIG. 7 depicts sensing and resource selection windows of Rel-16 NR V2X sidelink mode 2. When resource selection is triggered on slot n, based on sensing results in the sensing window 702, i.e., on slots [n−T₀, n−T_{proc,0}], the transmitting UE selects the resources in the resource selection window 704 in a resource pool, i.e., on slots [n+T₁, n+T₂], where:
T₀: number of slots with the value determined by resource pool configuration.
T_{proc,0}: time required for a UE to complete the sensing process.
T₁: processing time required for identification of candidate resources and resource selection T₁≤T_{proc,1}.
T₂: the last slot of resource pool for resource selection which is left to UE implementation but in the range of [T₂ₘᵢₙ, PDB] where T₂ₘᵢₙ is minimum value of T₂ and PDB denotes packet delay budget, the remaining time for UE transmitting the data packet.
T_{proc,1}: maximum time required for a UE to identify candidate resources and select new sidelink resources.

### NR Positioning Methods

Several positioning methods are available in NR (TS 38.305), which include DL-based solutions, UL-based solutions, and DL- and UL-based solutions.

### DL Based Solutions

Timing based technique—Downlink Time Difference of Arrival (DL-TDOA): Similar to OTDOA in LTE, NR specified DL-TDOA positioning, which measures the timing difference of DL-PRS on LOS paths from different gNBs.

Angle-based techniques—Downlink angle(s) of departure (DL-AOD): NR introduced angle-based positioning techniques. In DL-AOD, UE measures the received power based on DL-PRS and estimates the AOD from different gNBs based on the measured power difference among PRS/beam from the same TRP.

### UL Based Solutions

Timing based technique—Uplink Time Difference of Arrival (UL-TDOA): Different from LTE, NR introduced an UL positioning technique using an UL positioning signal which is configured UL SRS. gNBs measure the UL timing difference from the UE.

Angle-based techniques-Uplink angle(s) of arrival (UL-AOA): Similar to DL-AOD, gNBs measures the AOA from the UE using the UL SRS configured for positioning purposes. gNBs measures both zenith AOA and azimuth AOA to obtain a 3D location.

### DL and UL Based Solutions

Timing based technique-Multi-cell round trip time (multi-RTT): In multi-RTT, the UE measures the UE Rx-Tx time difference and gNBs measures the gNB Rx-Tx time difference. The RTT can be estimated with two Rx-Tx time differences for each UE-gNB pair. For Rx-Tx time difference measurement, DL PRS and UL SRS are configured and transmitted from gNBs and the UE, respectively.

Enhanced Cell-ID (E-CID): E-CID based positioning is based on RRM measurements, i.e., RSRP, RSRQ, via synchronization signals (i.e., SSB measurement) and CSI-RS. UL AOA is also supported.

The positioning method selection, configuration of the reference signals (SRS, PRS) and collection of the measurements is orchestrated by the Location Management Function (LMF) that resides in the network (TS 38.305). The LMF manages the support of different location services for target UEs, including positioning of UEs and delivery of assistance data to UEs. The LMF may interact with the serving gNB or serving ng-eNB for a target UE to obtain position measurements for the UE, including uplink measurements made by an NG-RAN and downlink measurements made by the UE that were provided to an NG-RAN as part of other functions such as for support of handover.

### SL-PRS

In Rel-18 a new sidelink positioning reference signal (SL-PRS) was defined. The signal, which was based on DL PRS, consists of a pseudo-random sequence, which has a comb distribution in frequency (Comb-N), for example where every Nth subcarrier carries a portion of the pseudo-random sequence, and occupies M symbols in a slot. The comb structure in some embodiments is defined in TS 38.211.

In the sidelink, the SL-PRS may be transmitted either in a shared resource pool or in a dedicated resource pool. For SL-PRS transmission, either dedicated resource pool(s) or shared resource pool(s) or both can be configured, or pre-configured, in the only SL BWP of a carrier. A UE can be configured, or pre-configured, with one or more dedicated SL resource pools. A UE can be configured, or pre-configured, with one or more shared SL resource pools.

A UE can be configured to perform either resource allocation Scheme 1 (e.g., gNB schedules and allocates resources) or Scheme 2 (e.g., each UE performs independent resource selection and reservation), applicable to all resource pools (for example, dedicated or shared resource pools).

SL PRS unicast/groupcast/broadcast can occur in either a shared or a dedicated resource pool.

### Shared Resource Pool

The shared resource pool (RP) is shared with the legacy sidelink transmissions (Rel-16, Rel-17). Regarding the SL Positioning resource allocation, and the SL Positioning resource configuration, or pre-configuration, in a shared resource pool with Rel-16/17/18 sidelink communication, backward compatibility with legacy Rel-16/17 UEs should be ensured. For a shared resource pool, SL PRS bandwidth is same as the bandwidth indicated for PSSCH. In FIG. 8, two current slot formats 802 and 804 are depicted using example values for the number of symbols for the PSCCH based on Rel-17 specifications. Two 11-PRB sub-channels are depicted. The bottom element of FIG. 8 shows how three fewer symbols available for the PSSCH. The location of the PSFCH is configurable.

### Dedicated Resource Pool

In a dedicated RP, the set of slots that belong to a resource pool is determined in the same way as the legacy SL communication pool (i.e., see section 8 of 38.214). TDM-based multiplexing of SL PRS from different UEs in a slot is supported. The comb sizes (N), for example {2, 4, 6}, are supported with possibility of full staggering. Comb-based multiplexing of SL PRS from different UEs in a slot is supported. Multiple (M, N) pairs within a slot in a dedicated resource pool is supported only when the different (M, N) pairs are always multiplexed via TDM to different sets of symbols in a slot. Only a single (M, N) value can be mapped within one TDM duration (e.g., one set of symbols).

For a dedicated resource pool for SL positioning, only a single stage SCI is used, SL-PRS cannot be transmitted in a slot without associated PSCCH. PSCCH and associated SL-PRS are TDMed in the same slot. The basic PSCCH structure is reused, that is the AGC and the gap symbols before and after the SCI. PSFCH and PSSCH are not included in a dedicated RP. SCI for SL-PRS should at least indicate the following values:
Source ID,
Destination ID,
Resource reservation period,
SL-PRS Priority, and
Cast type.

For Scheme 2, in a dedicated resource pool, multiple Li SL-PRS priorities are allowed in a resource pool.

There are two distinct technical problems to be solved. Each problem may have multiple sub-problems that can be considered. The first problem to solve is defining the first stage and second stage SCI for shared resource pools. For this first problem, a first constraint is the compatibility with the existing/legacy first stage SCI, which must be decoded by the legacy devices and may be used for resource selection even if they are not the target of the transmission. For this first problem, a second issue to solve is regarding resource selection, and reservation for retransmissions. For instance, it may happen that the SL-PRS transmitter has no data to transmit, in this case only SL-PRS resources will be selected and used to transmit. The PSSCH and SL-PRS may have different priorities, which impact resource selection. How these priorities are used when either PSSCH and SL-PRS or SL-PRS only transmissions are scheduled should be considered.

A second problem is to define the single stage SCI for the dedicated resource pools for SL-PRS transmission. Once the single SCI is defined, the resource allocation specifics for SL-PRS needs to be identified. It is noted that there are differences with respect to the legacy resource allocation for sidelink. One difference is that SL-PRS from different UEs can be multiplexed in the same slot (e.g., TDMed or comb-based), which implies additional information to be considered and provided.

### Shared Resource Pool Solutions

### First Stage SCI

When examining the existing SCI format 1-A, there is just one priority field, “Priority.” This priority field is set by the application. With support of positioning, there are two different applications corresponding to the PSSCH and to SL-PRS, respectively, which can impact the priority field.

The priority field is important as it impacts the resource selection and congestion control. SL UEs process the received priority field and compare it with their own priority for resource selection and congestion control.

This disclosure provides embodiments for setting the priority field in 1^{st} stage SCI when the slot contains PSSCH and SL-PRS.

One embodiment is when PSSCH and SL-PRS are TDMed in the same slot, the PSSCH priority is selected and placed in the priority field. This approach has less impact on the ongoing legacy traffic, as any resource reservation or congestion control will not be impacted by the presence of SL-PRS transmission.

In another embodiment, the UE selects the higher priority value between PSSCH priority value and SL-PRS priority value. When the transmission contains only SL-PRS, for instance because data (PSSCH) is not available, the SL-PRS priority may be used. This approach may potentially impact the legacy traffic, as the SL-PRS may have higher priority than existing resource reservations, which may be overridden.

In at least one embodiment, to protect transmissions from the legacy devices the priority value used for resource selection is the minimum value between PSSCH priority and SL-PRS priority. This approach, however, may increase the latency of those transmissions that multiplex PSSCH and SL-PRS, as the SL-PRS may have lower priority than data (PSSCH).

In the legacy SCI format 1-A, the field ‘Time resource assignment’ carries logical slot offset indication of N=1 or 2 actual resources (e.g., slots) when sl-MaxNumPerReserve is 2, and N=1 or 2 or 3 actual resources when sl-MaxNumPerReserve is 3 where the first resource is in the slot where SCI format 1-A was received, and tᵢ denotes i-th resource time offset in logical slots of a resource pool with respect to the first resource where for N=2, 1≤t₁≤31; and for N=3, 1≤t₁≤30, t₁<t₂≤31. Thus, PSSCH may be retransmitted later based on HARQ feedback indication in PSFCH.

The value of the field ‘Time resource assignment’ specified in SCI format 1-A does not necessarily imply that the same data (PSSCH) is transmitted, or that the same destination is used, and the like.

For the purposes of clarity, the term “retransmission” for those future reservations that are specified in the SCI format 1-A, and the term of “periodic transmissions” for those transmissions that are periodically and that are configured by higher layer. The periodic transmissions are characterized in general by a larger period and larger number of repetitions than those transmissions that use the multiple time resource assignments (e.g., reservations) in 1st stage SCI format 1-A (called in this disclosure “retransmissions”).

The time intervals between each periodic transmission may vary as some delay can occur when resources are unavailable at the expected period. For the reasons of increased robustness, coverage, or precision, the SL-PRS transmission can be repeated in the reserved resources (e.g., retransmissions) either to the same parameters (e.g., destination, spatial filter, BW) or different.

The signaling of reserved resources for retransmissions needs to be preserved when PSSCH and SL-PRS are multiplexed in the same slot. In this case, a retransmission may or may not contain the SL-PRS signal depending on the application and it may or it may not have the same destination or cast types.

The data (PSSCH) and positioning RS may have different requirements in terms of robustness and periodicity; therefore, it may not be necessary that the PSSCH and SL-PRS are always transmitted together. Thus, the new second stage SCI may indicate whether the transmissions, or re-transmissions, have only SL-PRS or both for the ongoing transmission, which may be set independently.

The multiplexing of PSSCH and SL-PRS together may impact the resource selection and reservation. The issue to be addressed is how to select/reserve future resources (for retransmission) when the initial transmission contains both PSSCH and SL-PRS but in future resource reservations only one of them may be transmitted.

To address the above scenarios when future reservations (e.g., for possible retransmissions) have or not have PSSCH and SL-PRS multiplexed, two distinct resource selections, one selection for data (PSSCH) only transmission for instance using a legacy format (SCI), and another resource selection/reservation for those transmissions, or re-transmissions, when SL-PRS may be included using the SCI are described in this disclosure. As described, PSSCH and SL-PRS may have different priorities, therefore the selection of each retransmission resource may have different requirements.

Other embodiments may have a number of resource reservations in the future and do not make distinction whether the retransmission contain or not contain PSSCH and SL-PRS multiplexed. At the time of the retransmission (e.g., usage of the reserved resources) the new SCI may indicate the presence/absence of PSSCH or SL-PRS, where the SCI (2nd stage) specifies whether the SL-PRS, data or both are included and their corresponding resources, address, and the like. In other words, the resource selection and reservation for retransmissions is performed as if PSSCH and SL-PRS are always in the same slot even if one of them is not transmitted.

The 1st stage SCI has a field “2nd-stage SCI format” with a size of 2 bits as defined in Table 8.3.1.1-1 in 38.212. Only one value of this field (‘11’) is reserved. If only this value were used to identify a new 2^{nd} stage format, it may limit future/additional 2^{nd} stage definitions. For the backward compatibility with the existing devices, SCI format 1-A should remain as unchanged as possible.

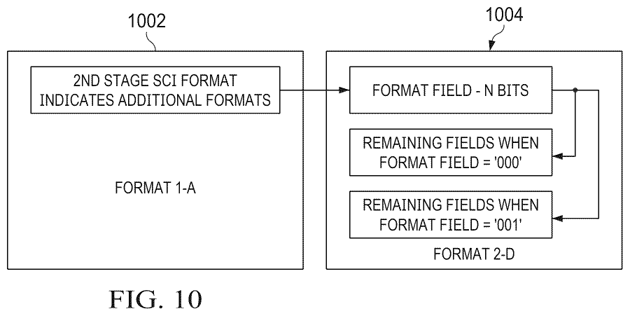

Several embodiments may be considered. In at least one embodiment, the reserved value of the field “2nd-stage SCI format” indicates a class of new 2nd stage SCI of formats, where the specific type of the new 2^{nd} stage SCI in that class is coded/indicated in a new format field in the 2^{nd} stage SCI. This new format field will be used to interpret or indicate the specific format of the 2^{nd} stage SCI. Thus, future sidelink releases may create new SCI formats. FIG. 10 depicts an example linkage of format 1-A 1002 to the format field of a new second stage DCI 1004.

For the above solution for signaling of a new format in 2^{nd} stage SCI, the size of the 2^{nd} stage SCI should have a known size at the receiver. One way to assure this known size is by having all the new formats be the same size (for instance determine the size of the largest format and for those formats whose size is smaller, appending (padding with) an appropriate number of bits so the format sizes are equal). A receiver can be told to disregard the contents of the appended bits.

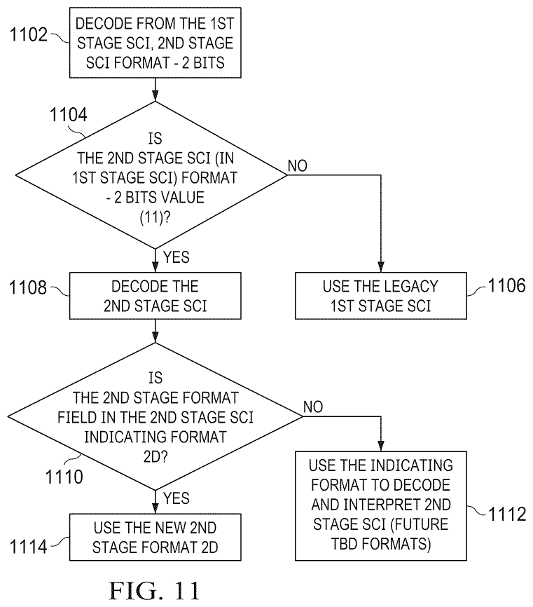

FIG. 11 shows examples of decoding and interpretation of 1^{st} and 2nd stage SCI respectively that implements described solutions.

In FIG. 11, the receiving UE decodes the 1^{st} stage SCI at 1102, and interprets the 2^{nd} stage format field at 1104, which indicates a new class of second stage SCI formats. Then the receiving UE decodes the 2^{nd} stage SCI at 1108, and uses the new 2^{nd} stage format field from the 2^{nd} stage SCI to interpret the bits of the 2^{nd} stage SCI at 1114.

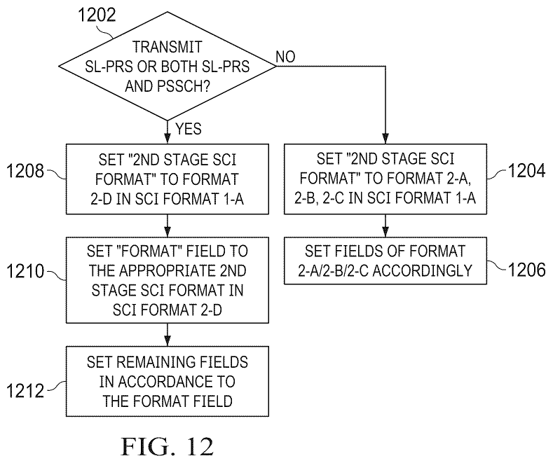

FIG. 12 illustrates an example procedure to the set the SCIs. At 1202, a determination is made to transmit a SL-PRS or both a SL-PRS and a PSSCH. In a circumstance where both a SL-PRS and a PSSCH are transmitted, at 1208 a “2^{nd}-stage SCI format” is set to format 2-D (e.g. a value of 11) in SCI format 1-A. At 1210, a “format” field is set to an appropriate 2^{nd}-stage SCI format in SCI format 2-D. In this regard, in some embodiments for sidelink transmissions, the sidelink control information (SCI) is transmitted in two stages. The first stage is provided in PSCCH (Physical Sidelink Control Channel), while the second stage is provided in PSSCH (Physical Sidelink Shared Channel). The first stage in PSCCH provides the information utilized to decode the PSSCH. In some embodiments, the PSSCH carries both second stage of the SCI and data. In this regard, the appropriate 2^{nd} stage SCI format represents the SCI second stage corresponding to the data that is multiplexed in PSSCH in that slot. In some embodiments, the appropriate 2^{nd}-stage SCI format is one of the legacy SCI formats, for example SCI format 2-A, 2-B, or 2-C. At 1212, the remaining fields are set in accordance with information of the format field, for example SCI format 2-A, 2-B, or 2-C indicated in the format field set at 1210. The remaining fields may include SL-POS reference signal resource information and at least part of fields of SCI format 2-A, 2-B, or 2-C.

In a circumstance where a SL-PRS only is to be transmitted, at 1204 a 2^{nd}-stage SCI format is set to format 2-A, 2-B, or 2-C in SCI format 1-A. At 1206, fields of format 2-A, 2-B, and/or 2-C are set accordingly.

In other words, each of the SCI stages contains a 2^{nd} stage SCI field format, where the 2^{nd} format field (2 bits) at 1104 in the 1^{st} stage SCI indicates the legacy 2^{nd} stage formats (A/B/C) at 1106 and a new class of 2^{nd} stage SCI formats at 1108. The 2^{nd} stage format field in the 2^{nd} stage SCI may have a different number of bits {2,3,4} and identify the second stage SCI format 2-D (for instance using value ‘00’, or ‘000’, or ‘0000’), and any other future formats will be indicated by the reserved values (for instance ‘01’/‘10’/‘11’, and the like).

In another embodiment, the identity of a new 2^{nd} stage SCI is still indicated by the 1^{st} stage SCI. To achieve this, one may use the reserved value (‘11’) of the field “2nd-stage SCI format” and n bits in conjunction. For instance, these n bits may be obtained from the pool of reserved bits indicated by configuration field sl-NumReservedBits {2 . . . 4}. This implies that for the shared RP to support SL-PRS transmissions, sl-NumReservedBits {2 . . . 4} always should be configured.

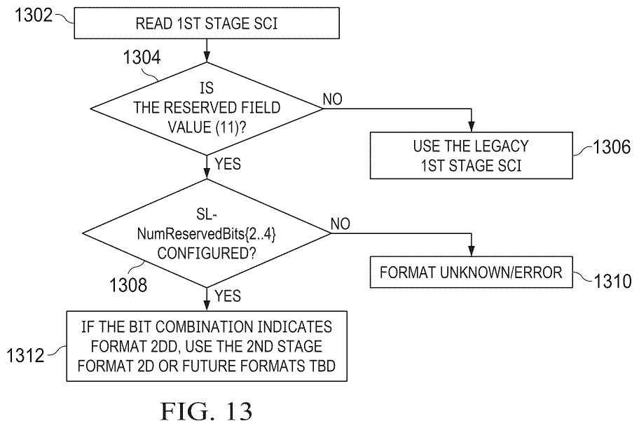

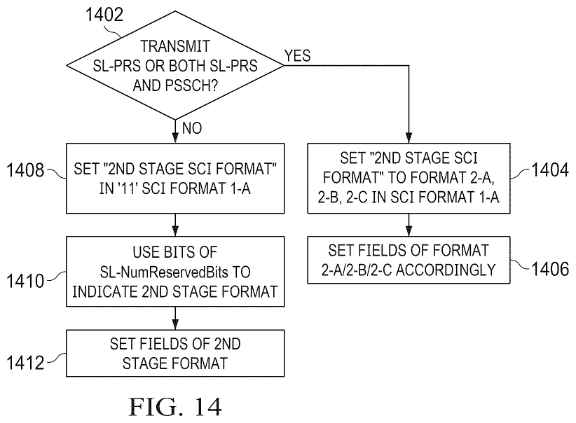

An example embodiment is presented in the flowcharts in FIG. 13 and FIG. 14. In this case, at 1302, the receiving UE decodes the 1^{st} stage SCI. At 1304, if the 2^{nd} stage SCI field format bits have value (11), at 1308 the receiving UE uses the reserved bits (bit 2, 3, 4) indicated in sl-NumReservedBit configuration to identify the format of the 2^{nd} stage SCI. If the bit combination indicates the format 2-D, then the 2^{nd} stage format 2-D or any specified 2^{nd} stage format is utilized at 1312. If the bit combination does not indicate the format 2-D, the format may be unknown or an error may be produced in some embodiments, or the indication may be handled utilizing another process in at least one other embodiment. If the receiving UE decodes the 1^{st} stage SCI and the reserved field value is not (11), or another specific bit combination in other embodiments, at 1306 a legacy 1^{st} stage SCI is used.

FIG. 14 depicts a procedure to set the SCI fields accordingly. At 1402, the SL-PRS or both SL-PRS and PSSCH are transmitted. If one is transmitted, at 1408, the 2^{nd} stage SCI format is set to “11” in the SCI format 1-A, in some embodiments. At 1410, bits of sl-NumReservedBits are used to indicate a 2^{nd} stage format accordingly, as described further herein. At 1412, fields of the 2^{nd} stage format are set, for example according to the 2^{nd} stage format indicated at 1410.

At 1404 in the flowchart, a 2^{nd} stage SCI format is set to one of a legacy formats, for example 2-A, 2-B, or 2-C, in SCI format 1-A. At 1406, the corresponding fields of the legacy format 2-A, 2-B, and/or 2-C are set accordingly.

### Second Stage SCI

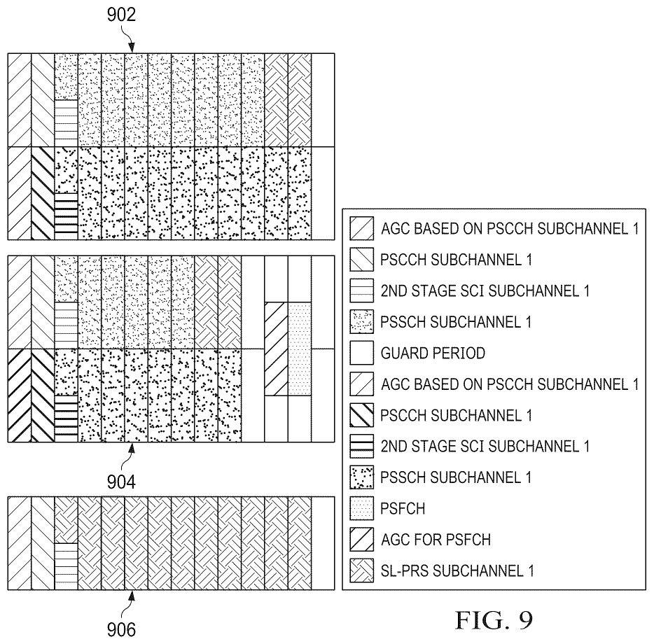

In a shared resource pool, the SL-PRS is transmitted within a slot in consecutive symbols. In a shared resource pool, SL-PRS, associated PSCCH and PSSCH scheduled by the PSCCH are included in the same slot. With regards to PSSCH and SL-PRS multiplexing, only TDMing (time division multiplexing) is supported for the comb sizes 1, 2, 4. The PSSCH is used for the 2^{nd} stage SCI (sidelink control information). There is no multiplexing between SL-PRS from different UEs. For a shared resource pool, SL PRS transmit power is same as that for PSSCH. FIG. 9 shows an example where one subchannel uses a two symbol TDM SL-PRS, specifically depicting slot formats 902, 904, and 906.

In a shared RP in addition to SL PRS transmission, SCI format 1-A & a 2^{nd} stage SCI format to be used for SL-PRS indication. Therefore, a new 2^{nd} stage SCI format should be defined.

Another possible scenario (and/or issue) to be considered is whether the data (PSSCH) and SL-PRS may have different destinations and different cast types. If PSSCH and SL-PRS have different unicast destinations, the 2nd stage SCI would need to provide separate destination ID and cast information. A receiver may need to decode the entire 2^{nd} stage SCI and determine whether the target destination is either of PSSCH, or SL-PRS, or both. In this regard, when the receiver decodes the second stage of the control information, the receiver can identify whether the rest of PSSCH carries data only, SL-PRS only, or both. In some embodiments the receiver identifies such information depending on the specific control information and the format of the specific control information respectively.

Based on the specific application, a SL-PRS may be multicast to a group of SL UEs, where the group for instance may be identified by the geographic zone, SL-PRS RSRP or another metric. Those receivers that satisfy the constraint will use the received SL-PRS for positioning purposes (for instance tracking, ranging or position update).

For periodic transmissions, the resource reservation period is indicated in 1^{st} stage SCI by the same field name. In at least one embodiment SL-PRS periodic transmissions may contain a sequence of SL-PRS with different characteristics (such as destination, spatial filter, BW), which are repeated periodically.

One issue to address is how this resource reservation period will be set if periodic transmissions PSSCH and SL-PRS have different periods. This decision may be taken at the higher layers. In one example case, when one period is the integer multiple of the other, the transmitter may reserve resources corresponding to the minimum period of PSSCH and SL-PRS transmissions. In this case the 2^{nd} stage SCI identifies the structure of each transmission, which may contain PSSCH and SL-PRS, SL-PRS or PSSCH only (in this case first stage may indicate a 2A legacy format).
Based on the above observations, some specific designs of the 1^{st} stage SCI and 2^{nd} stage SCI for shared resource pools may be considered.
Based on the previous comments, one embodiment solution is that the 2^{nd} stage SCI for the slots carrying PSSCH and SL-PRS to contain all or a subset of the following information:
[New] field that identifies the 2^{nd} stage SCI format.
HARQ process number—4 bits.
New data indicator—1 bit.
Redundancy version—2 bits as defined in Table 7.3.1.1.1-2.
Source ID—8 bits as defined in clause 8.1 of [6, TS 38.214].
Destination ID—16 bits as defined in clause 8.1 of [6, TS 38.214].
Cast type indicator—2 bits as defined in Table 8.4.1.1-1 and in clause 8.1 of [6, TS 38.214].
HARQ feedback enabled/disabled indicator—1 bit as defined in clause 16.3 of [5, TS 38.213].
[new] Field that indicates whether SL-PRS or both PSSCH and SL-PRS are present (1 bit)
PSSCH resource information (time, frequency)
PSSCH transmission period if different than period indicated in the 1st stage SCI
Cast type indicator for SL-PRS [may be different than PSSCH cast type]
SL-PRS resource information (comb, comb offset, #symbols, starting symbol, resource identifier (ID))
SL-PRS transmission period (if different than the period indicated in the 1st stage SCI)
SL-PRS number of retransmissions
SL-PRS resources reserved for retransmission
Additional information to limit the availability of SL-PRS receivers (geographic zone, SL-PRS RSRP, and the like)
Trigger of SL-PRS transmissions
Destination ID for SL-PRS-16 bits as defined in clause 8.1 of [6, TS 38.214].

In particular, the cast type and additional Destination ID may be absent (or otherwise optional) when they must coincide with the corresponding field of PSSCH.

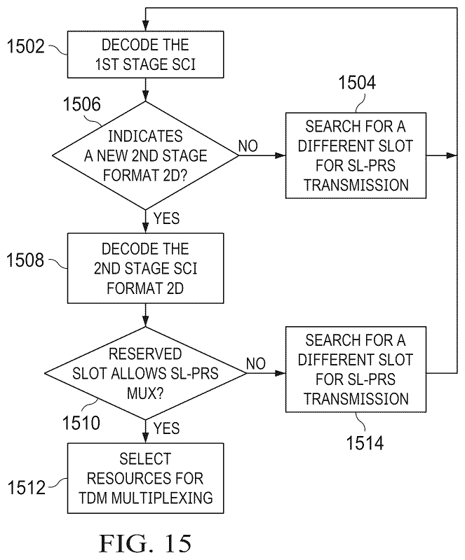

In a different embodiment illustrated by FIG. 15, a slot may have TDMed SL-PRS transmissions from different UEs.

While this scenario is not supported in Rel-18, future releases may support it. Note that TDM is allowed in the dedicated resource pools.

In this embodiment, at 1502 a UE checks ongoing transmissions (via decoding 1st stage SCI) to identify whether resources are suitable for SL-PRS transmissions with TDM multiplexing from other UEs. For example at 1506, a UE determines if the decoded data indicates a new 2^{nd} stage format 2-D. If the decoded data does not, at 1504, the UE searches for a different slot for SL-PRS transmission. If the decoded data does indicate a new 2nd stage format 2-D, at 1508 the UE decodes the 2^{nd} stage SCI format 2-D. If, at 1510, the reserved slot allows for SL-PRS multiplexing, the UE selects resources for TDM multiplexing at 1512. If the reserved slot does not allow for SL-PRS multiplexing, at 1514, the UE searches for a different slot for SL-PRS transmission.

The new 2nd stage SCI format 2D carries a field of information, which enables or disable multiplexing in the reserved resources.

In this embodiment the 2nd stage SCIs are multiplexed TDM or FDM, where each 2nd stage SCI corresponds to a SL-PRS.

There can be a fixed mapping between resources for 2nd stage SCI and SL-PRS allowed TDM symbols.

The 2nd stage SCIs may need AGC and guard symbols between, all the second stages have same MCS and same 2nd stage SCI format and priority as signal in the 1st stage SCI, which is common.

The transmitter SL UE will transmit the same 1st stage SCI, different 2nd stage SCI and different SL-PRS which are one to one mapped (for example, via pre-coding and specific to the shared resource pool).

When there are both PSSCH and SL-PRS in a slot, the formula for determining the transport block size needs to be updated. In clause 8.1.3.2 of 38.214. First the UE determines the number of resource elements in a PRB according to:
A UE first determines the number of REs allocated for PSSCH within a

$$PRB ( {N}_{RE}^{′} ) by {N}_{RE}^{′} = {N}_{sc}^{R B} ( {N}_{s y m b}^{s h} - {N}_{s y m b}^{P S F C H} ) - {N}_{o h}^{P R B} - {N}_{R E}^{D M R S} ,$$

$${N}_{s c}^{R B} = 12$$

is the number of subcarriers in a physical resource block,

$${N}_{s y m b}^{s h} = sl - LengthSymbols - 2 ,$$

where sl-LengthSymbols is the number of sidelink symbols within the slot provided by higher layers,

$${N}_{s y m b}^{PSFCH} = 3$$

if ‘PSFCH overhead indication' field of SCI format 1-A indicates “1”, and

$${N}_{s y m b}^{PSFCH} = 0$$

otherwise, if higher layer parameter sl-PSFCH-Period is 2 or 4. If higher layer parameter sl-PSFCH-Period is 0,

$${N}_{s y m b}^{PSFCH} = 0 .$$

It higher layer parameter sl-PSFCH-Period is 1,

$${N}_{s y m b}^{PSFCH} = 3 .$$

$${N}_{o h}^{PRB}$$

is the overhead given by higher layer parameter sl-X-Overhead,

$${N}_{R E}^{DMRS}$$

is given by Table 8.1.3.2-1 according to higher layer parameter sl-PSSCH-DMRS-TimePatternList.

When SL-PRS is to be transmitted, the formula should account for the number of symbols occupied by SL-PRS,

$${N}_{s y m b}^{SL - PRS} .$$

This number is obtained from the SL-PRS fields in the new 2^{nd} stage SCI format. A possible update is

$${N}_{RE}^{′} = {N}_{s c}^{R B} ( {N}_{s y m b}^{s h} - {N}_{s y m b}^{PSFCH} - {N}_{s y m b}^{SL - P R S} ) - {N}_{o h}^{PRB} - {N}_{R E}^{DMRS} .$$

As it was mentioned above, in the legacy SCI format 1-A, the field ‘Time resource assignment’ carries logical slot offset indication of N=1 or 2 actual resources (e.g., slots) when sl-MaxNumPerReserve is 2, and N=1 or 2 or 3 actual resources when sl-MaxNumPerReserve is 3 where the first resource is in the slot where SCI format 1-A was received.

These 2, or 3, time resources are reserved for subsequent transmissions from the same UE.

Given that in shared resource pools, data carried in PSSCH (SL-SCH) and SL-PRS may have different constraints or purposes. For the SL-PRS, further transmissions, or re-transmissions, in the reserved resources may or may not be necessary. In other words, in shared resource pools, a subsequent transmission indicated in the SCI format 1-A reservations of a slot containing PSSCH and SL-PRS multiplexed may contain either PSSCH only, SL-PRS only or both.

SCI format 1-A corresponding to a slot that contains both PSSCH and SL-PRS indicates a new second stage SCI 2-D, which supports at least the legacy content of SCI associated with data transmissions (e.g., format 2-A and 2-B), as well as the necessary control fields for SL-PRS transmissions.

The legacy control formats 2-A and 2-B are to be supported by SCI format 2-D for transmissions of data and SL-PRS multiplexing, where the sidelink data transmission part has the legacy format (before Release-18).

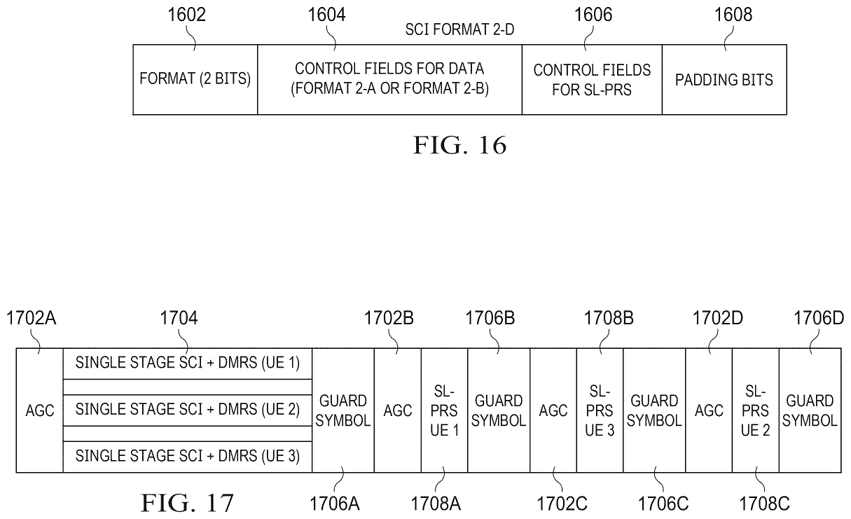

FIG. 16 depicts an example SCI format 2-D. The example SCI format 2-D includes a field format of 2 bits 1602, control fields for data 1604, for example legacy formats 2-A or 2-B, control fields for SL-PRS 1606, and subsequent padding bits 1608. It will be appreciated that in other embodiments, the fields may have differing lengths, as described herein. Additionally or alternatively, in some embodiments, one or more of the fields may be optional, as described herein.

SCI format 2-D contains a field format (two bits), which indicates that the control fields for the SL-SCH (data) has legacy format 2-A when they have the value “00”. When the value of these bits is set to “01” the codeword indicates that SCI format 2-D carries the format 2-B for data part. In at least one embodiment the Format field is located at the start of Format 2-D, such that the Format may be read first sequentially.

It is noted that SCI format 2-A is used for the scheduling of PSSCH with various types of expected HARQ operation. The HARQ operation can indicate the feedback (HARQ-ACK information) from the receiving UE after the receiving UE decodes the PSSCH. For example, HARQ-ACK information can include ACK or NACK, HARQ-ACK information can include only NACK, or there is no feedback of HARQ-ACK information. SCI format 2-B is used for the scheduling of PSSCH with HARQ operation when HARQ-ACK information includes only NACK, or when there is no feedback of HARQ-ACK information. The control fields' length does not need to be the same for format 2-A or 2-B.

There are situations when the control fields of SCI format 2-A and 2-B are not necessary because there is no SL-SCH carried in PSSCH (i.e., no data, just positioning signal). In some such cases, only the scheduling information pertaining to SL-PRS may be carried in SCI format 2-D. In some embodiments only the scheduling information pertaining to SL-PRS is necessary to be carried in the SCI format 2-D.

There are a couple of ways to handle these situations. In the SCI format 2-A or SCI format 2-B portion of SCI format 2-D, one way is to set all or some of the fields that are associated with SL-SCH such as HARQ process number, new data indicator, redundancy version, and the like, to zero “0” or one “1” values while keeping the fields associated with SL-PRS. Instead of all “0” or “1”, there may be different patterns used.

A SCI format 2-D that schedules only SL-PRS and no SL-SCH (data) may use value of “00” to indicate SCI format 2-A plus the SL-PRS related fields, where the fields of the format 2-A associated with SCI-SCH have all value one (“1”). In another embodiment these fields have all value zero (“0”). In at least one embodiment, the Control fields for data (format 2-A or format 2-B) occur immediately after the Format field, such that the SL-PRS only usage is determined sequentially after the Format and Control.

In a different embodiment, a SCI format 2-D that schedules only SL-PRS and no SL-SCH (data) may use value of “01” to indicate SCI format 2-B plus the SL-PRS related fields, where the fields of the format 2-B associated with SCI-SCH all have the value one (“1”). In another embodiment these fields all have the value zero (“0”).

In another embodiment, the SCI format 2-D that schedules only SL-PRS is indicated through the format fields of SCI format 2-D with a different codeword value, “10” for example.

Because it is expected that SCI format 2-D has the same bit length for different transmissions, i.e., irrespective of the codeword value of the format field, when the codeword value is “10”, the SCI is padded with the necessary number of bits, which can have all value one “1”, or, in a different embodiment value zero “0”. In another embodiment the padding bits are “reserved,” where any particular value cannot be assumed at the receiver. Because the Control fields may be of different lengths depending on the Format field, the padding bits may also be of different lengths. It is noted that this third solution allows different arrangement of the SL-PRS control fields in the SCI 2-D, and it also allows specific control fields for SL-PRS transmission only.

In an additional embodiment, parts of the Control fields are set to a known value (“0” or “1”,) to identify the SL-PRS only, while the remaining bits may be repurposed for additional fields for the SL-PRS only case.

RAN1 agreed previously that:
1. For a shared resource pool, SL PRS transmit power is same as that for PSSCH.
2. For a shared resource pool, SL PRS bandwidth is same as the bandwidth indicated for PSSCH.

Related to the above scenarios, other design solutions should be considered. For instance, consider the scenario when an initial transmission has SL-SCH and SL-PRS multiplexed but a subsequent transmission(s) in one of the reserved resources indicated by SCI format 1-A has only SL-PRS transmission. Such a SL-PRS transmission may have different destination, cast type or purpose than the previous SL-PRS transmission, thus a different BW and transmit power. Given that such a SL-PRS transmission has no SL-SCH, it is important to define the BW and power allocated to the SL-PRS signal.

For instance, for SL-PRS transmit power a solution may consist of same symbol-level Tx power between PSCCH and SL PRS.

With regard to the bandwidth (BW), the BW value for SL-PRS may be provided in SCI Format 1-A, via the field used to indicate BW for SL SCH in the legacy format and the BW of SL-PRS may be of any value that PSSCH bandwidth can have.

### Dedicated Resource Pools Solutions

For dedicated resource pools, a single stage SCI should be defined. This SCI will contain the information utilized to receive the SL-PRS part of the transmission, for example any necessary information utilized. It is noted that multiple SL-PRS from different UEs in the same slot can be multiplexed (e.g., TDMed or comb-based), where each SL-PRS has an associated single stage SCI. For this reason, the SCI themselves should be multiplexed (for example, multiplexed in frequency as shown in FIG. 17). One embodiment includes SCIs from different UEs are multiplexed in frequency, for example the various single stage SCIs 1704, and they have configured, or pre-configured, resources, which are corresponding (e.g., mapped) to each SL-PRS, for example each SL-PRS 1708A, 1708B, and 1708C. Possible multiplexing of the SCI may be via comb-based multiplexing, where each SCI has a different comb index, or repetition in frequency (e.g., non-overlapping SCI). In some embodiments an AGC symbol is necessary in the first symbol of the transmission (e.g., a slot). The AGC may be a duplication of the first symbol of each SCI. Each SCI may be associated with its own DMRS for SCI decoding. DMRS also are multiplexed together with the SCI (e.g., preferably in either in the adjacent and/or interlaced subcarriers SCI data for a better channel model).

FIG. 17 depicts an example slot format as seen at a receiver (e.g., a receiving UE).

AGC symbols, for example the AGC symbols 1702A-1702D, and guard symbols, for example 1706A-1706D, for Tx-RX switch are present at the receiver. The example shows TDM multiplexing of different SL-PRS transmissions from different SL UEs in the same slot. Each SL-PRS may have a different comb size. The location of the single stage SCI and DMRS may be uniquely mapped configured, or pre-configured, to the resources of each SL-PRS.

For SL-PRS multiplexing in frequency (e.g., comb-based) a single AGC symbol may correspond to a group of symbols (e.g., a TDM) that carry multiple SL-PRS with the same comb-size.

In another embodiment the two multiplexing types (e.g., TDM and comb-based) may be in the same slot and each is indicated in the corresponding single stage SCI.

For the DMRS, this disclosure provides reusing the specification for DMRS 1st stage SCI format 1-A.

Some examples of the information carried in the single stage SCI are listed here:
Source ID
Destination ID
Priority
Cast type indicator
Associated information for multicast/broadcast such as validity area [zone], validity duration
Number and period of retransmissions
Period of transmission (Resource reservation period)
SL-PRS resources (time—symbols, frequency such as subchannels)
Comb index
Type of multiplexing allowed with this transmission: TDM, comb based
Type of multiplexing allowed within retransmissions/periodic reserved resources
Trigger for other SL-PRS transmission (example for RTT)

Given that different types of multiplexing are allowed, the resource selection and reservation procedure established for legacy sidelink should be changed. More precisely, in addition the resources that can be multiplexed (e.g., comb, symbols) should be considered as selected resources and based on the priorities to be used for reservation and transmissions. When the multiplexing is done different UEs may have different period of their SL-PRS or different priority. Thus, each resource multiplexed should be judged individually for its availability.

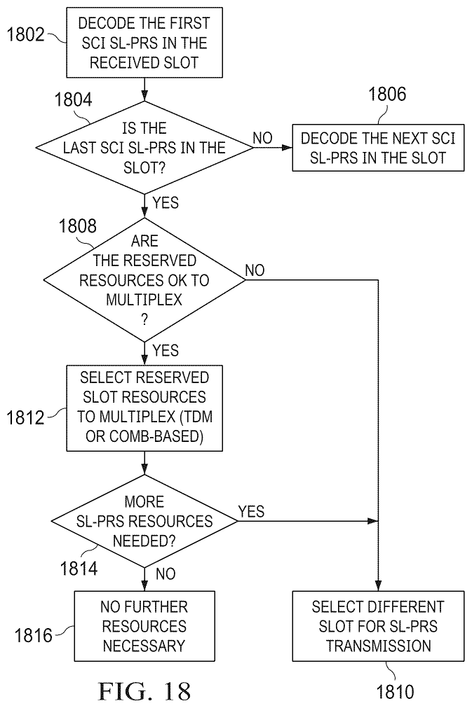

FIG. 18 depicts an example resource selection at a UE that is to multiplex its SL-PRS transmissions with existing multiplexed SL-PRS repetitions.

The UE must decode each single stage SCI of the multiplexed transmissions and decide whether in future repetitions what type of multiplexing is allowed, whether there is room for multiplexing and how its SL-PRS priority relates to existing priorities. If the resources are not sufficient or the multiplexing is not allowed, additional resource selections and reservations may be necessary.

At 1802, the UE decodes the first SCI SL-PRS in the received slot. At 1804, the UE determines if the SCI SL-PRS is a last SCI SL-PRS in the slot. If the first SCI SL-PRS is determined not to be the last SCI SL-PRS in the slot, at 1806, the UE decodes the next SCI SL-PRS in the next slot.

If the first SCI SL-PRS is determined to be the last SCI SL-PRS in the slot, at 1808, the UE determines if the reserved resources are allowed to multiplex. If the UE determines that the reserved resources are not allowed to multiplex, at 1810 the UE selects a different slot for SL-PRS transmission. If the UE determines that the reserved resources are allowed to multiplex, at 1812, the UE selects the reserved slot resources to multiplex. For example, the UE may select one of TDM or comb-based multiplexing, or the like. At 1814, the UE determines if more SL-PRS resources are needed. If the UE determines that more SL-PRS resources are needed, the UE proceeds in accordance with 1810 to select a different slot for SL-PRS transmission. If the UE determines that more SL-PRS resources are not needed, at 1816, no further resources or further actions are required.

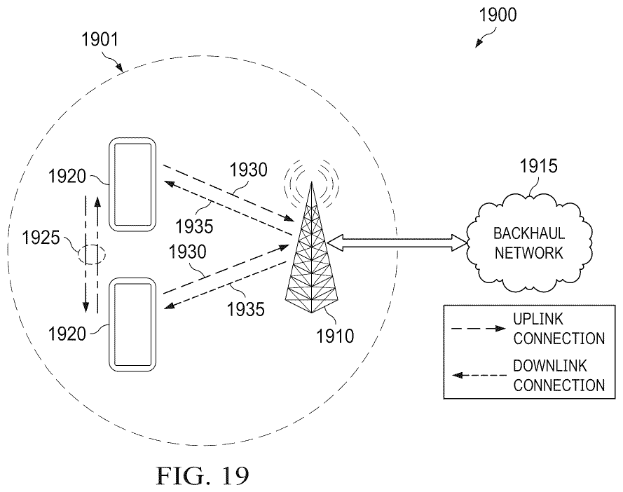

FIG. 19 illustrates an example communications system 1900. Communications system 1900 includes an access node 1910 serving user equipments (UEs) with coverage 1901, such as UEs 1920. In a first operating mode, communications to and from a UE passes through access node 1910 with a coverage area 1901. The access node 1910 is connected to a backhaul network 1915 for connecting to the internet, operations and management, and so forth. In a second operating mode, communications to and from a UE do not pass through access node 1910, however, access node 1910 typically allocates resources used by the UE to communicate when specific conditions are met. Communications between a pair of UEs 1920 can use a sidelink connection (shown as two separate one-way connections 1925). In FIG. 19, the sidelink communication is occurring between two UEs operating inside of coverage area 1901. However, sidelink communications, in general, can occur when UEs 1920 are both outside coverage area 1901, both inside coverage area 1901, or one inside and the other outside coverage area 1901. Communication between a UE and access node pair occur over uni-directional communication links, where the communication links between the UE and the access node are referred to as uplinks 1930, and the communication links between the access node and UE is referred to as downlinks 1935.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, and the like. While it is understood that communications systems may employ multiple access nodes capable of communicating with a number of UEs, only one access node and two UEs are illustrated for simplicity.

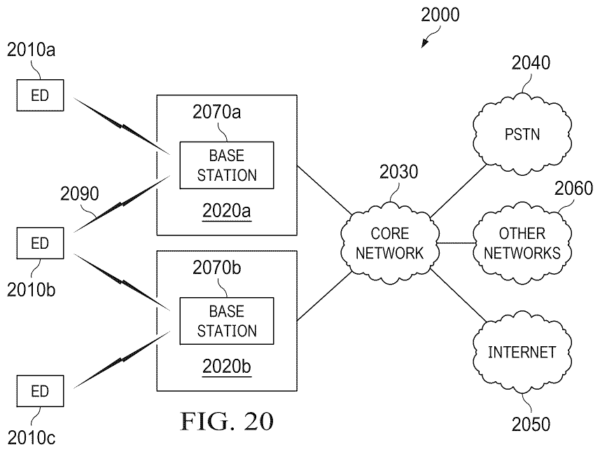

FIG. 20 illustrates an example communication system 2000. In general, the system 2000 enables multiple wireless or wired users to transmit and receive data and other content. The system 2000 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 2000 includes electronic devices (ED) 2010a-2010c, radio access networks (RANs) 2020a-2020b, a core network 2030, a public switched telephone network (PSTN) 2040, the Internet 2050, and other networks 2060. While certain numbers of these components or elements are shown in FIG. 20, any number of these components or elements may be included in the system 2000.

The EDs 2010a-2010c are configured to operate or communicate in the system 2000. For example, the EDs 2010a-2010c are configured to transmit or receive via wireless or wired communication channels. Each ED 2010a-2010c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 2020a-2020b here include base stations 2070a-2070b, respectively. Each base station 2070a-2070b is configured to wirelessly interface with one or more of the EDs 2010a-2010c to enable access to the core network 2030, the PSTN 2040, the Internet 2050, or the other networks 2060. For example, the base stations 2070a-2070b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 2010a-2010c are configured to interface and communicate with the Internet 2050 and may access the core network 2030, the PSTN 2040, or the other networks 2060.

In the embodiment shown in FIG. 20, the base station 2070a forms part of the RAN 2020a, which may include other base stations, elements, or devices. Also, the base station 2070b forms part of the RAN 2020b, which may include other base stations, elements, or devices. Each base station 2070a-2070b operates to transmit or receive wireless signals within a particular geographic region or area, sometimes referred to as a “cell.” In some embodiments, multiple-input multiple-output (MIMO) technology may be employed having multiple transceivers for each cell.

The base stations 2070a-2070b communicate with one or more of the EDs 2010a-2010c over one or more air interfaces 2090 using wireless communication links. The air interfaces 2090 may utilize any suitable radio access technology.

It is contemplated that the system 2000 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 2020a-2020b are in communication with the core network 2030 to provide the EDs 2010a-2010c with voice, data, application, Voice over Internet Protocol (VOIP), or other services. Understandably, the RANs 2020a-2020b or the core network 2030 may be in direct or indirect communication with one or more other RANs (not shown). The core network 2030 may also serve as a gateway access for other networks (such as the PSTN 2040, the Internet 2050, and the other networks 2060). In addition, some or all of the EDs 2010a-2010c may include functionality for communicating with different wireless networks over different wireless links using different wireless technologies or protocols. Instead of wireless communication (or in addition thereto), the EDs may communicate via wired communication channels to a service provider or switch (not shown), and to the Internet 2050.

Although FIG. 20 illustrates one example of a communication system, various changes may be made to FIG. 20. For example, the communication system 2000 could include any number of EDs, base stations, networks, or other components in any suitable configuration.

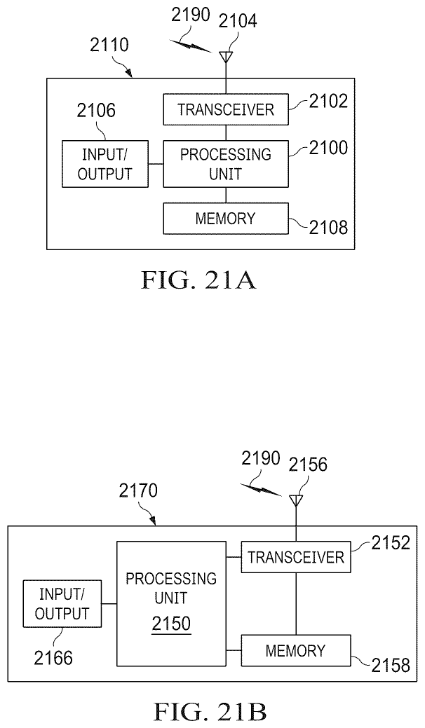

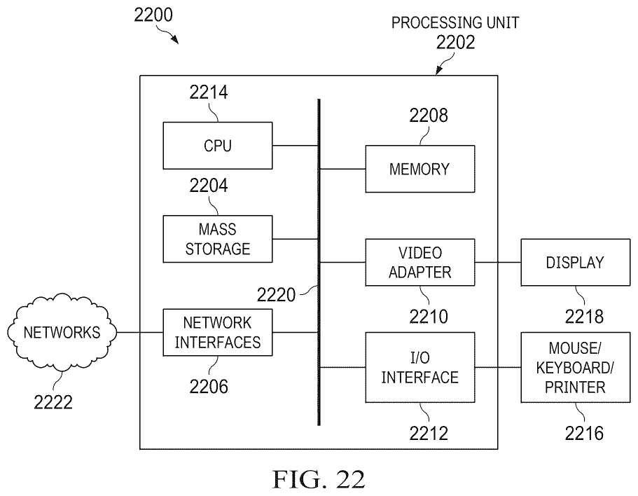

FIGS. 21A and 21B illustrate example devices that may implement the methods and teachings according to this disclosure. In particular, FIG. 21A illustrates an example ED 2110, and FIG. 21B illustrates an example base station 2170. These components could be used in the system 2000 or in any other suitable system.

As shown in FIG. 21A, the ED 2110 includes at least one processing unit 2100. The processing unit 2100 implements various processing operations of the ED 2110. For example, the processing unit 2100 could perform signal coding, data processing, power control, input/output processing, or any other functionality enabling the ED 2110a-c to operate in the system 2000. The processing unit 2100 also supports the methods and teachings described in more detail above. Each processing unit 2100 includes any suitable processing or computing device configured to perform one or more operations. Each processing unit 2100 could, for example, include a microprocessor, microcontroller, digital signal processor, field programmable gate array, or application specific integrated circuit.

The ED 2100 also includes at least one transceiver 2102. The transceiver 2102 is configured to modulate data or other content for transmission by at least one antenna or NIC (Network Interface Controller) 2104. The transceiver 2102 is also configured to demodulate data or other content received by the at least one antenna 2104. Each transceiver 2102 includes any suitable structure for generating signals for wireless or wired transmission or processing signals received wirelessly or by wire. Each antenna 2104 includes any suitable structure for transmitting or receiving wireless or wired signals. One or multiple transceivers 2102 could be used in the ED 2110, and one or multiple antennas 2104 could be used in the ED 2110. Although shown as a single functional unit, a transceiver 2102 could also be implemented using at least one transmitter and at least one separate receiver.

The ED 2110 further includes one or more input/output devices 2106 or interfaces (such as a wired interface to the Internet 2050). The input/output devices 2106 facilitate interaction with a user or other devices (network communications) in the network. Each input/output device 2106 includes any suitable structure for providing information to or receiving information from a user, such as a speaker, microphone, keypad, keyboard, display, or touch screen, including network interface communications.

In addition, the ED 2110 includes at least one memory 2108. The memory 2108 stores instructions and data used, generated, or collected by the ED 2110. For example, the memory 2108 could store software or firmware instructions executed by the processing unit(s) 2100 and data used to reduce or eliminate interference in incoming signals. Each memory 2108 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 21B, the base station 2170 includes at least one processing unit 2150, at least one transceiver 2152, which includes functionality for a transmitter and a receiver, one or more antennas 2156, at least one memory 2158, and one or more input/output devices or interfaces 2166. A scheduler, which would be understood by one skilled in the art, is coupled to the processing unit 2150. The scheduler could be included within or operated separately from the base station 2170. The processing unit 2150 implements various processing operations of the base station 2170, such as signal coding, data processing, power control, input/output processing, or any other functionality. The processing unit 2150 can also support the methods and teachings described in more detail above. Each processing unit 2150 includes any suitable processing or computing device configured to perform one or more operations. Each processing unit 2150 could, for example, include a microprocessor, microcontroller, digital signal processor, field programmable gate array, or application specific integrated circuit.

Each transceiver 2152 includes any suitable structure for generating signals for wireless or wired transmission to one or more EDs or other devices. Each transceiver 2152 further includes any suitable structure for processing signals received wirelessly or by wire from one or more EDs or other devices. Although shown combined as a transceiver 2152, a transmitter and a receiver could be separate components. Each antenna 2156 includes any suitable structure for transmitting or receiving wireless or wired signals. While a common antenna 2156 is shown here as being coupled to the transceiver 2152, one or more antennas 2056 could be coupled to the transceiver(s) 2152, allowing separate antennas 2156 to be coupled to the transmitter and the receiver if equipped as separate components. Each memory 2158 includes any suitable volatile or non-volatile storage and retrieval device(s). Each input/output device 2166 facilitates interaction with a user or other devices (network communications) in the network. Each input/output device 2166 includes any suitable structure for providing information to or receiving/providing information from a user, including network interface communications.

FIG. 22 is a block diagram of a computing system 2200 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, and the like. The computing system 2200 includes a processing unit 2202. The processing unit includes a central processing unit (CPU) 2214, memory 2208, and may further include a mass storage device 2204, a video adapter 2210, and an I/O interface 2212 connected to a bus 2220.

The bus 2220 may be one or more of any type of several bus architectures including a memory bus or memory controller, a peripheral bus, or a video bus. The CPU 2214 may comprise any type of electronic data processor. The memory 2208 may comprise any type of non-transitory system memory such as static random access memory (SRAM), dynamic random access memory (DRAM), synchronous DRAM (SDRAM), read-only memory (ROM), or a combination thereof. In an embodiment, the memory 2208 may include ROM for use at boot-up, and DRAM for program and data storage for use while executing programs.

The mass storage 2204 may comprise any type of non-transitory storage device configured to store data, programs, and other information and to make the data, programs, and other information accessible via the bus 2220. The mass storage 2204 may comprise, for example, one or more of a solid state drive, hard disk drive, a magnetic disk drive, or an optical disk drive.

The video adapter 2210 and the I/O interface 2212 provide interfaces to couple external input and output devices to the processing unit 2202. As illustrated, examples of input and output devices include a display 2218 coupled to the video adapter 2210 and a mouse, keyboard, or printer 2216 coupled to the I/O interface 2212. Other devices may be coupled to the processing unit 2202, and additional or fewer interface cards may be utilized. For example, a serial interface such as Universal Serial Bus (USB) (not shown) may be used to provide an interface for an external device.

The processing unit 2202 also includes one or more network interfaces 2206, which may comprise wired links, such as an Ethernet cable, or wireless links to access nodes or different networks. The network interfaces 2206 allow the processing unit 2202 to communicate with remote units via the networks. For example, the network interfaces 2206 may provide wireless communication via one or more transmitters/transmit antennas and one or more receivers/receive antennas. In an embodiment, the processing unit 2202 is coupled to a local-area network 2222 or a wide-area network for data processing and communications with remote devices, such as other processing units, the Internet, or remote storage facilities.

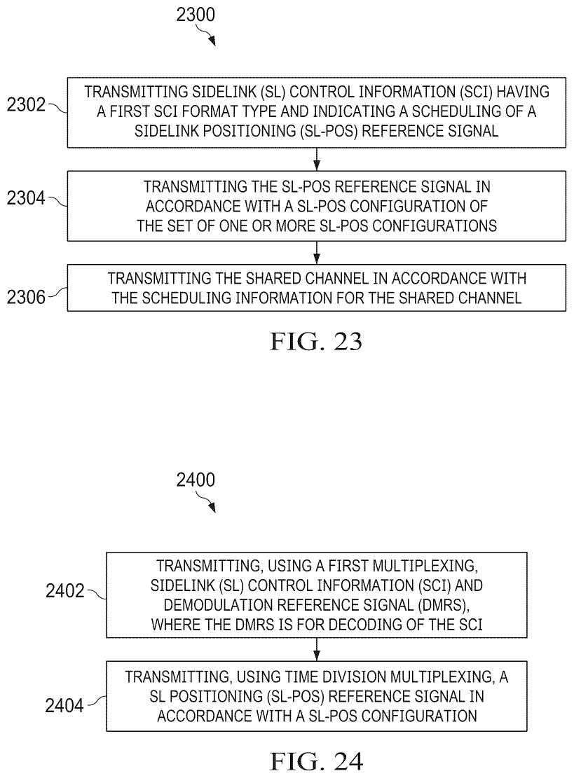

FIG. 23 depicts an example process 2300. In some embodiments, the process 2300 is performed by a first user equipment, for example a transmitting user equipment. The first user equipment may include be configured in accordance with the devices discussed throughout as embodiments of the present disclosure. The first user equipment in some embodiments includes computer-readable code or instructions executed on one or more processors of the first user equipment. Coding of the software for carrying out or performing the process 2300 is well within the scope of a person of ordinary skill in the art having regard to the present disclosure. The process 2300 may include additional or fewer operations than those shown and described and may be carried out or performed in a different order. Computer-readable code or instructions of the software executable by the one or more processors may be stored on a non-transitory computer-readable medium, such as for example, the memory of the first user equipment. In some embodiments, the process 2300 may be performed by one or more of units or modules (e.g., an integrated circuit) of the first user equipment, such as field programmable gate arrays (FPGAs) or application-specific integrated circuits (ASICs).

The process 2300 includes an operation 2302 of transmitting sidelink (SL) control information (SCI) having a first SCI format type and indicating a scheduling of a sidelink positioning (SL-POS) reference signal. The SCI includes an index to a set of one or more SL-POS configurations. The SCI further includes a format field indicating a second SCI format and fields of the second SCI format. The second SCI format indicates scheduling information for a shared channel. The second SCI format can be called an embedded or nested SCI format of the first SCI format. The first SCI format may be a 1^{st} stage SCI format, and the second SCI format may be a 2^{nd} stage SCI format, where the 2^{nd} stage SCI format may be at least one of SCI format 2-A, SCI format 2-B, SCI format 2-C, or SCI format 2-D. The first SCI format and the second SCI format both may be 2^{nd} stage SCI formats, as an example, the first SCI format is SCI format 2-D on PSSCH, and the second SCI format may be at least one of SCI format 2-A, SCI format 2-B or SCI format 2-C.

The process 2300 further includes an operation 2304 of transmitting the SL-POS reference signal in accordance with a SL-POS configuration of the set of one or more SL-POS configurations. In this regard, the SL-POS reference signal may be transmitted using a particular second SCI format and the fields of the second SCI format accordingly. In some embodiments the SL-POS reference signal is transmitted using a first multiplexing, which may be configured based on the SCI and/or any information thereof. The SL-POS reference signal may be multiplexed with information of other UEs, for example other SCI from other UEs, based on the SL-POS configuration, and/or other data of the SCI indicating the scheduling of the SL-POS reference signal.

The process 2300 further includes an operation 2306 of transmitting the shared channel in accordance with the scheduling information for the shared channel. In some embodiments, the shared channel is transmitted using a second multiplexing. The first multiplexing may be the same type of multiplexing as the second multiplexing, or in other embodiments may be a different type of multiplexing. The shared channel may be multiplexed with information of other UEs, for example based on the scheduling information.

In some embodiments, the indicator includes a second stage SCI format index to a subset of the SL-POS configurations represented in the set of one or more SL-POS configurations. In this regard, the indicator is indexed to a particular SL-POS configuration of the one or more SL-POS configurations.

In some embodiments, the SCI includes the index in a first portion. The first portion may be processed before at least a second portion of the SCI. Additionally or alternatively, the second portion may include the indicator of the second SCI format and the fields of the second SCI format.

In some embodiments, the indicator includes a value of a certain number of bits. For example, in some embodiments the indicator includes a two-bit value. In some embodiments, the indicator includes a three-bit value. In some embodiments, the indicator includes a four-bit value.

In some embodiments, a first combination of the bits in the indicator indicates a first 2^{nd} stage SCI format. For example, the first combination of bits may correspond to a SCI format 2-A. A second combination of bits in the indicator may indicate a second 2^{nd} stage SCI format. For example, the second combination of bits may correspond to a SCI format 2-B.

In some embodiments, the SCI includes a request field. The value in the request field may indicate to transmit the SL-POS reference signal based on a configuration provided by an upper layer.

In some embodiments, the SCI includes a priority associated with at least the SL-POS reference signal. The priority data may include different priorities for different SL-POS reference signals or other data. In some embodiments, the priority is associated with a SL-POS reference signal and is a first priority. The SCI may include a second priority associated with other PSSCH data associated with the shared channel. The priority of a multiplexed slot for the shared channel may be assigned based on the multiple priorities. For example, in some embodiments, the priority assigned is a higher of the first priority and the second priority.

In some embodiments, the other PSSCH data and the SL-POS reference signal are transmitted in a same slot.

FIG. 24 depicts an example process 2400. In some embodiments, the process 2400 is performed by a first user equipment, for example a transmitting user equipment. The first user equipment may include be configured in accordance with the devices discussed throughout as embodiments of the present disclosure. The first user equipment in some embodiments includes computer-readable code or instructions executed on one or more processors of the first user equipment. Coding of the software for carrying out or performing the process 2400 is well within the scope of a person of ordinary skill in the art having regard to the present disclosure. The process 2400 may include additional or fewer operations than those shown and described and may be carried out or performed in a different order. Computer-readable code or instructions of the software executable by the one or more processors may be stored on a non-transitory computer-readable medium, such as for example, the memory of the first user equipment. In some embodiments, the process 2400 may be performed by one or more of units or modules (e.g., an integrated circuit) of the first user equipment, such as field programmable gate arrays (FPGAs) or application-specific integrated circuits (ASICs).

The process 2400 includes an operation 2402 of transmitting, using a first multiplexing, sidelink (SL) control information (SCI) and demodulation reference signal (DMRS). In some embodiments, the DMRS is for decoding of the SCI. In some embodiments, the SCI includes or indicates SL-POS reference signal resource information, a format field indicating a second SCI format and/or fields of the second SCI format, and/or another indication of scheduling information for a shared channel. The SL-POS reference signal resource information includes at least one of SL-POS reference signal resource identifier, SL-POS reference signal request, or an index of a set of one or more SL-POS configurations.

The process 2400 includes an operation 2404 of transmitting, using a second multiplexing, an SL positioning (SL-POS) reference signal in accordance with a SL-POS configuration. In some embodiments, the second multiplexing is a time-division multiplexing. In some embodiments, the SL-POS is transmitted based on a SL-POS configuration, for example of a set of SL-POS configurations. In some embodiments the SL-POS configuration is determined based on a nested SCI format or other configuration information.

The SCI is a first SCI of at least one SCI associated with the at least one UE. The at least one SCI may include any number of other SCI associated with other UEs of the at least one UE. In this regard, each UE may correspond to a particular SCI of the at least one SCI. Similarly, each UE may correspond to a particular DMRS that is associated with decoding the SCI corresponding to that UE.

The SL-POS reference signal may include a first SL-POS reference signal of at least one reference signal. The at least one SL-POS reference signal may similarly include any number of other SL-POS reference signals associated with the other UEs of the at least one UE. In this regard, each UE may correspond to a particular SL-POS reference signal of the at least one SL-POS reference signal. Similarly, each SL-POS reference signal may correspond to a particular SCI, for example the SCI that is associated with the same UE corresponding to that particular SL-POS reference signal.

Different SCI may be multiplexed with each other SCI using a first multiplexing. Different SL-POS reference signals may be multiplexed together using a second multiplexing. The first multiplexing may be the same type of multiplexing as the second multiplexing in some embodiments, for example time division multiplexing or frequency division multiplexing. In other embodiments, the first multiplexing is of a different type than the second multiplexing, for example the first multiplexing is frequency division multiplexing and the second multiplexing is time division multiplexing.

In some embodiments, transmitting the at least one SL-POS reference signal includes transmitting the first SL-POS reference signal multiplexed via the time division multiplexing with a second SL-POS reference signal associated with a second UE. In other embodiments, multiple other SL-POS reference signals may be multiplexed.

In some embodiments, the first multiplexing is a frequency division multiplexing. In other embodiments, the first multiplexing is a time division multiplexing. It should be appreciated that any method of multiplexing may be utilized.

In some embodiments, the SCI and the DMRS are transmitted in a same slot as the at least one SL-POS reference signal. The data may be multiplexed to enable such same slot transmission.

In some embodiments, each SCI is mapped to a corresponding SL-POS reference signal of the at least one SL-POS reference signal. In this regard, an SCI and a corresponding SL-POS reference signal may be mapped for each UE of the at least one UE, such that each UE corresponds to a particular SCI and a particular corresponding SL-POS reference signal.

In some embodiments, an automatic gain control symbol and a guard symbol are provisioned between at least two successively transmitted SL-POS reference signals. Such symbols may differentiate signals accordingly. In some embodiments, the AGC symbol includes a duplication of the SL-POS reference signal, or another first SL-POS reference signal.

In some embodiments, the SCI is of a first SCI configuration. The first SCI configuration includes at least one bit that triggers requesting transmission of a corresponding SL-POS reference signal.

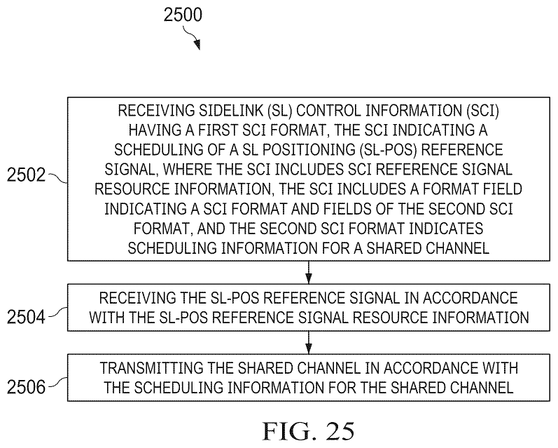

FIG. 25 depicts an example process 2500. In some embodiments, the process 2500 is performed by a first user equipment, for example a receiving user equipment. The first user equipment may include be configured in accordance with the devices discussed throughout as embodiments of the present disclosure. The first user equipment in some embodiments includes computer-readable code or instructions executed on one or more processors of the first user equipment. Coding of the software for carrying out or performing the process 2500 is well within the scope of a person of ordinary skill in the art having regard to the present disclosure. The process 2500 may include additional or fewer operations than those shown and described and may be carried out or performed in a different order. Computer-readable code or instructions of the software executable by the one or more processors may be stored on a non-transitory computer-readable medium, such as for example, the memory of the first user equipment. In some embodiments, the process 2500 may be performed by one or more of units or modules (e.g., an integrated circuit) of the first user equipment, such as field programmable gate arrays (FPGAs) or application-specific integrated circuits (ASICs).

The process 2500 includes an operation 2502 of receiving sidelink (SL) control information (SCI) having a first SCI format. The SCI indicates a scheduling of a SL positioning (SL-POS) reference signal. The SCI includes SL-POS reference signal resource information. In some embodiments, the SCI further includes a format field indicating a SCI format and fields of the second SCI format. In some embodiments, the second SCI format indicates scheduling information for a shared channel.

The process 2500 further includes an operation 2504 of receiving the SL-POS reference signal in accordance with the SL-POS reference signal resource information.

The process 2500 further includes an operation 2506 of transmitting the shared channel in accordance with the scheduling information for the shared channel. In some embodiments, the received SCI and/or the SL-POS reference signal may be utilized to transmit the shared channel accordingly.

In some embodiments, the SL-POS reference signal resource information includes at least one of an SL-POS reference signal resource identifier, an SL-POS reference signal request. The SL-POS reference signal resource identifier identifies a particular SL-POS configuration of the one or more SL-POS configurations.

In some embodiments, the SCI includes the index in a first portion. The first portion may be processed before at least a second portion of the SCI. Additionally or alternatively, the second portion may include the indicator of the second SCI format and the fields of the second SCI format.

In some embodiments, the indicator includes a value of a certain number of bits. For example, in some embodiments the indicator includes a two-bit value. In some embodiments, the indicator includes a three-bit value. In some embodiments, the indicator includes a four-bit value.

In some embodiments, a first combination of the bits in the indicator indicates a first 2^{nd} stage SCI format. For example, the first combination of bits may correspond to a SCI format 2-A. A second combination of bits in the indicator may indicate a second 2^{nd} stage SCI format. For example, the second combination of bits may correspond to a SCI format 2-B.

In some embodiments, the SCI includes a request field. The value in the request field may indicate to transmit the SL-POS reference signal based on a configuration provided by an upper layer.

In some embodiments, the SCI includes a priority associated with at least the SL-POS reference signal. The priority data may include different priorities for different SL-POS reference signals or other data. In some embodiments, the priority is associated with a SL-POS reference signal and is a first priority. The SCI may include a second priority associated with other PSSCH data associated with the shared channel. The priority of a multiplexed slot for the shared channel may be assigned based on the multiple priorities. For example, in some embodiments, the priority assigned is a higher of the first priority and the second priority.

In some embodiments, the other PSSCH data and the SL-POS reference signal are transmitted in a same slot.

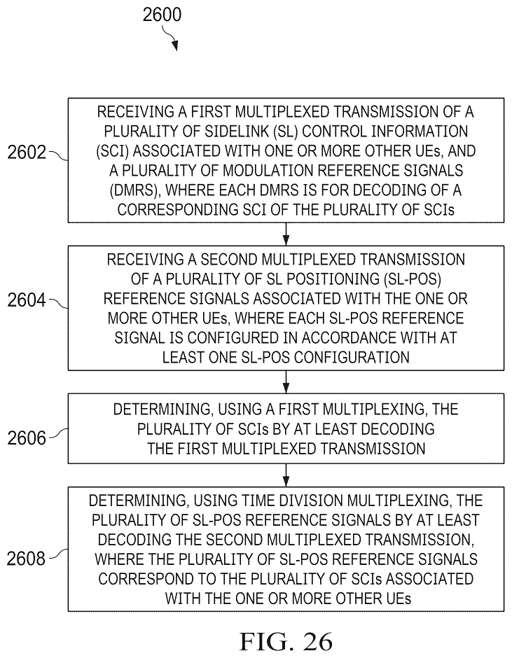

FIG. 26 depicts an example process 2600. In some embodiments, the process 2600 is performed by a first user equipment, for example a receiving user equipment. The first user equipment may include be configured in accordance with the devices discussed throughout as embodiments of the present disclosure. The first user equipment in some embodiments includes computer-readable code or instructions executed on one or more processors of the first user equipment. Coding of the software for carrying out or performing the process 2600 is well within the scope of a person of ordinary skill in the art having regard to the present disclosure. The process 2600 may include additional or fewer operations than those shown and described and may be carried out or performed in a different order. Computer-readable code or instructions of the software executable by the one or more processors may be stored on a non-transitory computer-readable medium, such as for example, the memory of the first user equipment. In some embodiments, the process 2600 may be performed by one or more of units or modules (e.g., an integrated circuit) of the first user equipment, such as field programmable gate arrays (FPGAs) or application-specific integrated circuits (ASICs).

The process 2600 includes an operation 2602 of receiving a first multiplexed transmission of a plurality of sidelink (SL) control information (SCI) associated with one or more other UEs, and a plurality of modulation reference signals (DMRS). Each DMRS is for decoding of a corresponding SCI of the plurality of SCIs. In this regard, each SCI associated with a particular UE may correspond to a particular DMRS associated with that particular UE. For example, in some embodiments, each SCI is a single stage SCI. The first multiplexed transmission may include data multiplexed with one another via time division multiplexing or another type of multiplexing (e.g., frequency division multiplexing).

The process 2600 further includes an operation 2604 of receiving a second multiplexed transmission of a plurality of SL positioning (SL-POS) reference signals associated with the one or more other UEs. In some embodiments, each SL-POS reference signal is configured in accordance with at least one SL-POS configuration. Each SL-POS reference signal may correspond to a particular SCI of the plurality of SCIs received. The second multiplexed transmission may include data multiplexed with one another via time division multiplexing or another type of multiplexing (e.g., frequency division multiplexing). It should be appreciated that the type of multiplexing utilized for the second multiplexed transmission may differ from the type of multiplexing utilized for the first multiplexed transmission, or in some embodiments may be the same type of multiplexing utilized for the first multiplexed transmission.

The process 2600 further includes an operation 2606 of determining, using a first multiplexing, the plurality of SCIs by at least decoding the first multiplexed transmission. In this regard, the first multiplexing may be utilized to decode the first multiplexed transmission. In some embodiments, the first multiplexing includes time division multiplexing or another type of multiplexing (e.g., frequency division multiplexing). The plurality of SCIs resulting from decoding the multiplexed transmission may include each SCI associated with a particular UE.

The process 2600 further includes an operation 2608 of determining, using time division multiplexing, the plurality of SL-POS reference signals by at least decoding the second multiplexed transmission. The plurality of SL-POS reference signals correspond to the plurality of SCI associated with the one or more other UEs. In some embodiments, the SL-POS corresponding to a particular SCI may be determined based on information from the particular SCI corresponding to that UE.

In some embodiments, receiving a first SL-POS reference signal associated with a first other UE multiplexed via the time division multiplexing with a second SL-POS reference signal associated with a second other UE.

In some embodiments, the first multiplexing is a frequency division multiplexing. In other embodiments, the first multiplexing is a time division multiplexing. It should be appreciated that any method of multiplexing may be utilized.

In some embodiments, the SCI and the DMRS are transmitted in a same slot as the at least one SL-POS reference signal. The data may be multiplexed to enable such same slot transmission.

In some embodiments, each SCI is mapped to a corresponding SL-POS reference signal of the at least one SL-POS reference signal. In this regard, an SCI and a corresponding SL-POS reference signal may be mapped for each UE of the at least one UE, such that each UE corresponds to a particular SCI and a particular corresponding SL-POS reference signal.

In some embodiments, an automatic gain control symbol and a guard symbol are provisioned between at least two successively transmitted SL-POS reference signals. Such symbols may differentiate signals accordingly. In some embodiments, the AGC symbol includes a duplication of the SL-POS reference signal, or another first SL-POS reference signal.

In some embodiments, the SCI is of a first SCI configuration. The first SCI configuration includes at least one bit that triggers requesting transmission of a corresponding SL-POS reference signal.

It should be appreciated that one or more operations of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other operations may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or operations, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or operations.

It should be appreciated that one or more operations of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other operations may be performed by an SCI transmitting unit/module, an SL-POS reference signal transmitting unit/module, a shared channel transmitting unit/module, an SCI receiving unit/module, an SL-POS reference signal receiving, an SCI decoding determining unit/module, an SL-POS reference signal decoding determining unit/module, a multiplexing module, and/or a de-multiplexing unit/module. The respective units/modules may be hardware, software, or a combination thereof. For instance, one or more of the units/modules may be an integrated circuit, such as field programmable gate arrays (FPGAs) or application-specific integrated circuits (ASICs).

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or operations, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or operations.

1. A method comprising:
transmitting, by a first user equipment (UE), a sidelink (SL) control information (SCI) on a physical sidelink shared channel (PSSCH), the SCI having a first SCI format and indicating a scheduling of a SL positioning (SL-POS) reference signal,
wherein the SCI comprises SL-POS reference signal resource information,
wherein the SCI comprises a format field indicating a second SCI format and fields of the second SCI format, and
wherein the second SCI format indicates scheduling information for a shared channel; and
transmitting, by the first UE, the SL-POS reference signal and the shared channel in accordance with the SCI.

2. The method of claim 1, wherein the SL-POS reference signal resource information comprises at least one of an SL-POS reference signal resource identifier or an SL-POS reference signal request.

3. The method of claim 1, wherein the first SCI format and the second SCI format are second stage SCI format, and the second SCI format is SCI format 2-A or SCI format 2-B.

4. The method of claim 1, wherein the SCI comprises a priority associated with at least the SL-POS reference signal.

5. The method of claim 4, wherein the priority associated with at least the SL-POS reference signal comprises a first priority, the SCI comprises a second priority associated with other physical sidelink shared channel (PSSCH) data associated with the shared channel, and wherein a priority of a multiplexed slot is assigned to a higher of the first priority and the second priority.

6. The method of claim 5, wherein the other PSSCH data and the SL-POS reference signal are transmitted in a same slot.

7. The method of claim 1, before the transmitting the SCI, the method further comprising:
transmitting, by the first UE, a first stage SCI having a second stage SCI format field indicating the first SCI format of the SCI, wherein the first SCI format is SCI format 2-D.

8. A method comprising:
receiving, by a first user equipment (UE), a sidelink (SL) control information (SCI) on a physical sidelink shared channel (PSSCH), the SCI having a first SCI format and indicating a scheduling of a SL positioning (SL-POS) reference signal,
wherein the SCI comprises SL-POS reference signal resource information,
wherein the SCI comprises a format field indicating a second SCI format and fields of the second SCI format, and
wherein the second SCI format indicates scheduling information for a shared channel; and
receiving, by the first UE, the SL-POS reference signal and the shared channel in accordance with the SCI.

9. The method of claim 8, wherein the SL-POS reference signal resource information comprises at least one of SL-POS reference signal resource identifier or SL-POS reference signal request.

10. The method of claim 8, wherein the first SCI format and the second SCI format are second stage SCI format, the second SCI format is SCI format 2-A or SCI format 2-B.

11. The method of claim 8, wherein the SCI comprises a priority associated with the SL-POS reference signal.

12. The method of claim 11, wherein the priority associated with at least the SL-POS reference signal comprises a first priority, the SCI comprises a second priority associated with other physical sidelink shared channel (PSSCH) data associated with at least the shared channel, and wherein a priority of a multiplexed slot is assigned to a higher of the first priority and the second priority.

13. The method of claim 12, wherein the other PSSCH data and the SL-POS reference signal are transmitted in a same slot.

14. The method of claim 8, before the receiving the SCI, the method further comprising:
receiving, by the first UE, a first stage SCI having a second stage SCI format field indicating the first SCI format of the SCI, wherein the first SCI format is SCI format 2-D.

15. A non-transitory computer-readable medium having instructions stored thereon that, when executed by a first user equipment (UE), cause the first UE to perform operations, the operations comprising:
transmitting a sidelink (SL) control information (SCI) on a physical sidelink shared channel (PSSCH), the SCI having a first SCI format and indicating a scheduling of a SL positioning (SL-POS) reference signal,
wherein the SCI comprises SL-POS reference signal resource information,
wherein the SCI comprises a format field indicating a second SCI format and fields of the second SCI format, and
wherein the second SCI format indicates scheduling information for a shared channel; and
transmitting the SL-POS reference signal and the shared channel in accordance with the SCI.

16. The non-transitory computer-readable medium of claim 15, wherein the SL-POS reference signal resource information comprises at least one of an SL-POS reference signal resource identifier or an SL-POS reference signal request.

17. The non-transitory computer-readable medium of claim 15, wherein the first SCI format and the second SCI format are second stage SCI format, and the second SCI format is SCI format 2-A or SCI format 2-B.

18. The non-transitory computer-readable medium of claim 15, wherein the SCI comprises a priority associated with at least the SL-POS reference signal.

19. The non-transitory computer-readable medium of claim 18, wherein the priority associated with at least the SL-POS reference signal comprises a first priority, the SCI comprises a second priority associated with other physical sidelink shared channel (PSSCH) data associated with the shared channel, and wherein a priority of a multiplexed slot is assigned to a higher of the first priority and the second priority.

20. The non-transitory computer-readable medium of claim 19, wherein the other PSSCH data and the SL-POS reference signal are transmitted in a same slot.
